(19) United States
(12) Patent Application Publication
(10) Pub. No.: US 2026/0010085 A1
(43) Pub. Date: Jan. 8, 2026

(54) NON-MAGNETIC ONE-COMPONENT DEVELOPING TONER AND METHOD FOR PRODUCING NON-MAGNETIC ONE-COMPONENT DEVELOPING TONER

(71) Applicant: KYOCERA Document Solutions Inc., Osaka (JP)

(72) Inventor: Hiroki UEMURA, Osaka (JP)

(73) Assignee: KYOCERA Document Solutions Inc., Osaka (JP)

(21) Appl. No.: 19/242,480

(22) Filed: Jun. 18, 2025

(30) Foreign Application Priority Data
Jul. 2, 2024 (JP) 2024-106669

(51) Int. Cl. G03G 9/093; G03G 9/08; G03G 9/097; G03G 15/08

(52) U.S. Cl. CPC G03G 9/09321; G03G 9/0819; G03G 9/09371; G03G 9/09392; G03G 9/09733; G03G 15/0808; G03G 15/0812; G03G 2215/0614

(57) ABSTRACT

A non-magnetic one-component developing toner comprises toner particles each including a toner core particle containing binder resin and a shell layer coating the toner core particle, and the toner particle contains no magnetic powder. The shell layer is formed using spherical resin particulates containing charge controlling resin. The toner particles have an average particle size of 6 μm or more and 8 μm or less, and when a surface of the toner particle is observed using a scanning electron microscope, a structure derived from the spherical resin particulates is not observed in the shell layer, and the outer surface of the shell layer is smoothed. When a cross section of the toner particle is observed using a transmission electron microscope, a crack derived from an interface between the resin particulates is observed inside the shell layer, in a direction substantially perpendicular to a surface of the toner core particle.

### INCORPORATION BY REFERENCE

This application is based upon and claims the benefit of priority from the corresponding Japanese Patent Application No. 2024-106669 filed Jul. 2, 2024, the entire contents of which are hereby incorporated by reference.

### BACKGROUND

The present disclosure relates to an electrostatic latent image developing toner. In particular, the present disclosure relates to non-magnetic one-component developing toner consisting of non-magnetic toner, and a method for producing non-magnetic one-component developing toner.

Generally, in an electrophotographic process, a surface of an electrostatic latent image carrier is charged by corona discharge or the like, and then is exposed to a laser beam or the like so as to form an electrostatic latent image. The formed electrostatic latent image is developed by toner, and a toner image is formed. Further, the formed toner image is transferred onto a recording medium, and a high quality image is obtained. Usually, the toner used in the electrophotographic process is produced by mixing coloring agent, charge controlling agent, releasing agent, magnetic material, and the like into binder resin such as thermoplastic resin, and by performing kneading, crushing, and classifying so as to obtain toner particles (toner mother particles) having an average particle size of 5 μm or more and 10 μm or less. Further, in purpose of providing flowability to the toner, or providing appropriate electrification performance to the toner, or improving cleanability of the toner from the photosensitive drum, inorganic micropowder such as silica or titanium oxide is added to the toner mother particles.

As the toner described above, conventionally, in purposes of obtaining good fixing performance in a low temperature range, improving preservation stability at high temperature, improving blocking resistance, and others, core-shell structured toner is used, in which toner core particles using low melting point binder resin are coated with a shell material made of resin having a glass transition temperature (Tg) higher than that of the binder resin of the toner core particles.

### SUMMARY

Non-magnetic one-component developing toner according to one aspect of the present disclosure is constituted of toner particles each of which includes a toner core particle containing at least binder resin and a shell layer coating the toner core particle, the toner particle containing no magnetic powder. The shell layer is formed using spherical resin particulates containing charge controlling resin. The toner particles has an average particle diameter of 6 μm or more and 8 μm or less, and when a surface of the toner particle is observed using a scanning electron microscope, a structure derived from the spherical resin particulates is not observed in the shell layer, and further an outer surface of the shell layer is smoothed. When a cross section of the toner particle is observed using a transmission electron microscope, a crack derived from an interface between the resin particulates is observed inside the shell layer, in a direction substantially perpendicular to a surface of the toner core particle.

### BRIEF DESCRIPTION OF THE DRAWINGS

FIG. 1 is a schematic structure diagram of an image forming apparatus using non-magnetic one-component developing toner of the present disclosure.

FIG. 2 is a cross-sectional side view illustrating a schematic structure of an image forming unit including a developing unit, in FIG. 1.

FIG. 3 is a schematic diagram illustrating a part of a cross section of the non-magnetic one-component developing toner of the present disclosure.

FIG. 4 is a transmission electron microscope picture of a cross section of toner of the present disclosure 1.

FIG. 5 is a transmission electron microscope picture of a cross section of toner of the present disclosure 2.

FIG. 6 is a transmission electron microscope picture of a cross section of toner of the present disclosure 3.

FIG. 7 is a transmission electron microscope picture of a cross section of toner of comparative example 1.

FIG. 8 is a transmission electron microscope picture of a cross section of toner of comparative example 2.

FIG. 9 is a transmission electron microscope picture of a cross section of toner of comparative example 3.

FIG. 10 is a transmission electron microscope picture of a cross section of toner of comparative example 5.

### DETAILED DESCRIPTION

### 1. Overall Structure of Image Forming Apparatus

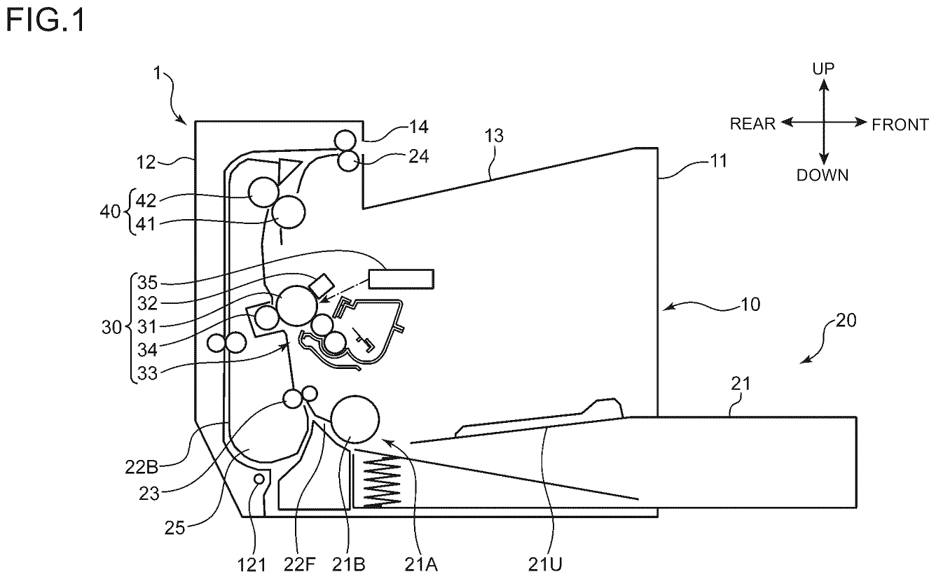

Hereinafter, with reference to the drawings, an embodiment of the present disclosure is described. FIG. 1 is a schematic cross-sectional view of an image forming apparatus 1 using non-magnetic one-component developing toner of the present disclosure. Note that in FIG. 1, the right side corresponds to the front side of the image forming apparatus 1, and the left side corresponds to the back side of the same.

The image forming apparatus 1 (here, a monochrome printer) includes a main body housing 10 having a substantially rectangular solid case structure, as well as a paper feeding unit 20, an image forming unit 30, and a fixing unit 40, which are housed in the main body housing 10. A front side of the main body housing 10 is provided with a front cover 11, and a back side thereof is provided with a back cover 12. Each unit of the image forming unit 30 can be put in and taken out from the back side of the main body housing 10 when the back cover 12 is opened. In addition, a top surface of the main body housing 10 is provided with a paper discharge unit 13 on which a sheet after image formation is discharged. Note that in the following description, the term “sheet” means a copy paper sheet, a coated paper sheet, an OHP sheet, a cardboard sheet, a postcard, a tracing paper sheet, or other sheet on which an image is formed.

The paper feeding unit 20 includes a paper feed cassette 21 that stores the sheet on which an image is formed. The paper feed cassette 21 is partially protruded from the front of the main body housing 10. A part of the upper face of the paper feed cassette 21, which is housed in the main body housing 10, is covered with a paper feed cassette top plate 21U. The paper feed cassette 21 includes a paper sheet storing space in which the sheets are stored, a lift plate that lifts up the sheets for paper feeding. An upper part of the paper feed cassette 21 on the back end side is provided with a paper sheet feed unit 21A. This paper sheet feed unit 21A includes a paper feed roller 21B for feeding the sheets in the paper feed cassette 21 one by one from a top sheet.

The image forming unit 30 performs an image formation operation of forming a toner image (a developer image) on the sheet fed from the paper feeding unit 20. The image forming unit 30 includes a photosensitive drum 31, as well as a charging unit 32, an exposing unit 35, a developing unit 33, and a transfer roller 34, which are disposed around the photosensitive drum 31.

The photosensitive drum 31 (an image carrier) includes a rotation shaft, and an outer periphery (a drum main body) that rotates about the rotation shaft. The outer periphery of the photosensitive drum 31 is provided with a photosensitive layer made of a known organic photo conductor (OPC), for example, constituted of a charge generating layer, a charge transporting layer, and the like. The photosensitive layer is charged uniformly by the charging unit 32 that will be described later, and is exposed with a light beam from the exposing unit 35 so as to form an electrostatic latent image with attenuated charge, and carries a toner image after the developing unit 33 develops the electrostatic latent image.

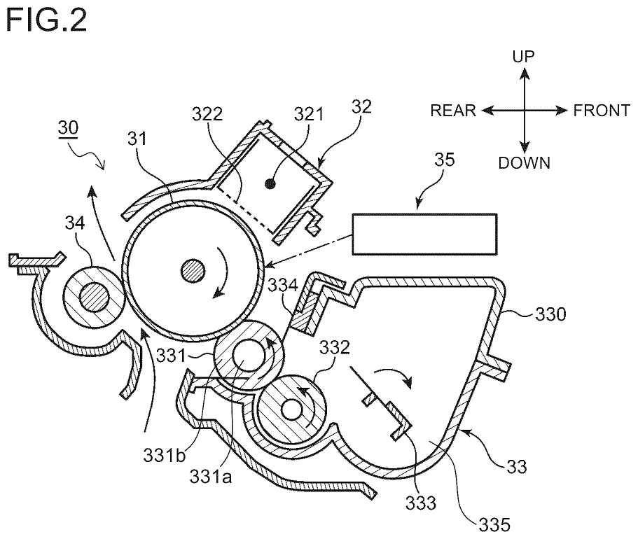

The charging unit 32 (a charging device) is disposed near the outer periphery of the photosensitive drum 31 with a predetermined gap, so as to uniformly charge the outer periphery of the photosensitive drum 31 in a noncontact state. Specifically, the charging unit 32 includes a charge wire 321 and a grid electrode 322 (see FIG. 2 for both). The charge wire 321 is a linear electrode extending in a rotation shaft direction of the photosensitive drum 31, and generates corona discharge between itself and the photosensitive drum 31. The grid electrode 322 is a grid-like electrode extending in the rotation shaft direction of the photosensitive drum 31, and is disposed between the charge wire 321 and the photosensitive drum 31. The charging unit 32 allows a current of a predetermined current value to flow in the charge wire 321 so as to generate corona discharge, and applies a predetermined voltage to the grid electrode 322, so as to uniformly charge the outer periphery of the photosensitive drum 31 facing the grid electrode 322, at a predetermined surface potential.

The exposing unit 35 (an exposure device) includes a laser light source and optical equipment such as a mirror and a lens, so as to emit light modulated on the basis of image data supplied from an external device such as a personal computer, to the outer periphery of the photosensitive drum 31. In this way, the exposing unit 35 forms an electrostatic latent image corresponding to the image based on the image data, on the outer periphery of the photosensitive drum 31.

The developing unit 33 (a developing device) can be attached and detached from the main body housing 10, and supplies non-magnetic one-component toner (developer) to the outer periphery of the photosensitive drum 31, so as to develop the electrostatic latent image formed on the outer periphery of the photosensitive drum 31. To develop the electrostatic latent image means to form the toner image (the developer image) that is a visualized image of the electrostatic latent image. Detailed structure of the developing unit 33 will be described later.

The transfer roller 34 is a roller for transferring the toner image formed on the outer periphery of the photosensitive drum 31 to the sheet. Specifically, the transfer roller 34 rotates about its axis, and has an outer periphery that faces the outer periphery of the photosensitive drum 31 at a position on a downstream side of a developing roller 331 in a rotation direction of the photosensitive drum 31. The transfer roller 34 transfers the toner image carried on the outer periphery of the photosensitive drum 31 to the sheet that passes a nip part between itself and the outer periphery of the photosensitive drum 31. When performing the transferring, the transfer roller 34 is applied with a transfer voltage having a polarity opposite to that of the toner.

The fixing unit 40 performs a fixing process of fixing the toner image transferred onto the sheet to the sheet. The fixing unit 40 includes a fixing roller 41 and a pressure roller 42. The fixing roller 41 has a heat source inside, so as to heat the toner transferred onto the sheet at a predetermined temperature. The pressure roller 42 is pressed to contact the fixing roller 41, and a fixing nip part is formed between itself and the fixing roller 41. When the sheet with the transferred toner image passes through the fixing nip part, the toner image is heated by the fixing roller 41 and is pressed by the pressure roller 42, so as to be fixed to the sheet.

In the main body housing 10, a main conveying path 22F and a reverse conveying path 22B are formed so as to convey the sheet. The main conveying path 22F extends from the paper sheet feed unit 21A of the paper feeding unit 20 via the image forming unit 30 and the fixing unit 40 to a paper discharge outlet 14, which is disposed to face the paper discharge unit 13 on the top surface of the main body housing 10. The reverse conveying path 22B is a conveying path for performing duplex printing on the sheet, i.e., for returning the sheet after printing on one side to an upstream side of the image forming unit 30 in the main conveying path 22F.

### 2. Structure of Image Forming Unit 30

FIG. 2 is a cross-sectional view of the image forming unit 30 in the image forming apparatus 1 of this embodiment. As illustrated in FIG. 2, The developing unit 33 includes a developer housing 330 (a developer container), the developing roller 331 (a developer carrier), a feed roller 332, a stirring paddle 333, and a regulating blade 334.

The developer housing 330 stores non-magnetic one-component developer containing only toner, and houses the developing roller 331, the feed roller 332, the regulating blade 334, and the like. The developer housing 330 has a stirring chamber 335 that stores stirred developer (toner). The stirring paddle 333 is disposed in the stirring chamber 335. The stirring paddle 333 stirs the toner in the stirring chamber 335.

The developing roller 331 has a rotation shaft 331a and a roller portion 331b. The rotation shaft 331a is supported by a bearing portion (not shown) of the developer housing 330 in a rotatable manner. The roller portion 331b is a cylindrical member formed on the outer periphery of the rotation shaft 331a (a conductive base), and has a structure in which a coat layer (a urethane layer) is formed on a surface of a base material rubber (a silicone rubber layer) using a concavo-convex coating material such as urethane. The roller portion 331b rotates together with the rotation shaft 331a when the rotation shaft 33 la rotates. A toner layer (a developer layer) having a predetermined thickness is formed on the surface of the roller portion 331b. The layer thickness of the toner layer is regulated (uniformly adjusted to be a predetermined thickness) by the regulating blade 334 that will be described later. The toner layer is charged by static electricity due to friction between the regulating blade 334 and the roller portion 331b.

The developing roller 331 rotates, at a position facing the photosensitive drum 31, in a direction (a counterclockwise direction in FIG. 2), i.e., in a direction from the upstream side to the downstream side in the rotation direction of the photosensitive drum 31 (a clockwise direction in FIG. 2). In other words, the developing roller 331 rotates in the same direction as the photosensitive drum 31 at the position facing the photosensitive drum 31.

The feed roller 332 is disposed to face the developing roller 331. The feed roller 332 carries the developer stored in the stirring chamber 335 on the outer periphery. In addition, the feed roller 332 feeds the developer carried on the outer periphery to the developing roller 331.

The feed roller 332 rotates, at a position facing the developing roller 331, in a direction (the counterclockwise direction in FIG. 2), i.e., in the direction from the downstream side to the upstream side in the rotation direction of the developing roller 331 (the counterclockwise direction in FIG. 2). In other words, the feed roller 332 rotates in the direction opposite to the developing roller 331 at the position facing the developing roller 331. In order to move the toner from the feed roller 332 to the developing roller 331, the feed roller 332 is applied with a predetermined supply voltage (a DC voltage).

The developing roller 331 receives the developer fed from the feed roller 332 and maintains the toner layer on the outer periphery. Further, the developing roller 331 supplies the developer to the photosensitive drum 31. The lengths of the developing roller 331 and the feed roller 332 in the axial direction (the direction perpendicular to the paper of FIG. 2) are substantially the same as the length of the photosensitive drum 31 in the axial direction. In order to move the toner from the developing roller 331 to the photosensitive drum 31, the developing roller 331 is applied with a predetermined developing voltage (a DC voltage).

The regulating blade 334 is a thin plate-like member made of metal (such as stainless steel). The regulating blade 334 has a proximal end part 334a fixed to the developer housing 330 and a distal end part 334b as a free end. The regulating blade 334 contacts the outer periphery of the developing roller 331 on the upstream side of the facing position between the photosensitive drum 31 and the developing roller 331 in the rotation direction of the developing roller 331.

As the regulating blade 334 contacts the developing roller 331 at a constant regulation pressure (a contact line pressure), the thickness of the toner layer carried on the outer periphery of the developing roller 331 is adjusted to a uniform thickness. In this way, the regulating blade 334 regulates an amount of toner on the outer periphery of the developing roller 331. In addition, the regulating blade 334 rubs the toner carried on the outer periphery of the developing roller 331, so as to charge the toner. The contact line pressure of the regulating blade 334 on the developing roller 331 means a contact pressure per unit length of the regulating blade 334 at a contact position between the regulating blade 334 and the outer periphery of the developing roller 331. The regulation pressure of the regulating blade 334 is preferably 15 to 40 (N/m).

### 3. Structure of Non-Magnetic One-Component Developing Toner

The non-magnetic one-component developing toner of the present disclosure (hereinafter, also referred to simply as toner) includes toner core particles containing at least binder resin, and shell layers coating the toner core particles. Further, the shell layer coating the toner core particle is made of resin containing charge controlling resin, and is formed using spherical resin particulates.

In addition, when observing the surface of the toner of the present disclosure using a scanning electron microscope, a structure derived from the spherical resin particulates is not observed in the shell layers of the toner particles having an average particle diameter of 6 μm or more and 8 μm or less. Further, when a cross section of the toner of the present disclosure is observed using a transmission electron microscope, cracks, each of which is derived from an interface between the resin particulates, are observed inside the shell layer in a direction substantially perpendicular to a surface of the toner core particle. Hereinafter, a structure of the toner and materials of the toner are described.

In the toner of the present disclosure, the entire surface of the toner core particle is covered with the shell layer. The coating state of the surface of the electrostatic latent image developing toner covered with shell layer can be checked using a scanning electron microscope (SEM). In addition, a smoothing degree of the shell layer and inside of the shell layer of the electrostatic latent image developing toner can be checked by observing the cross section of the toner using a transmission electron microscope (TEM).

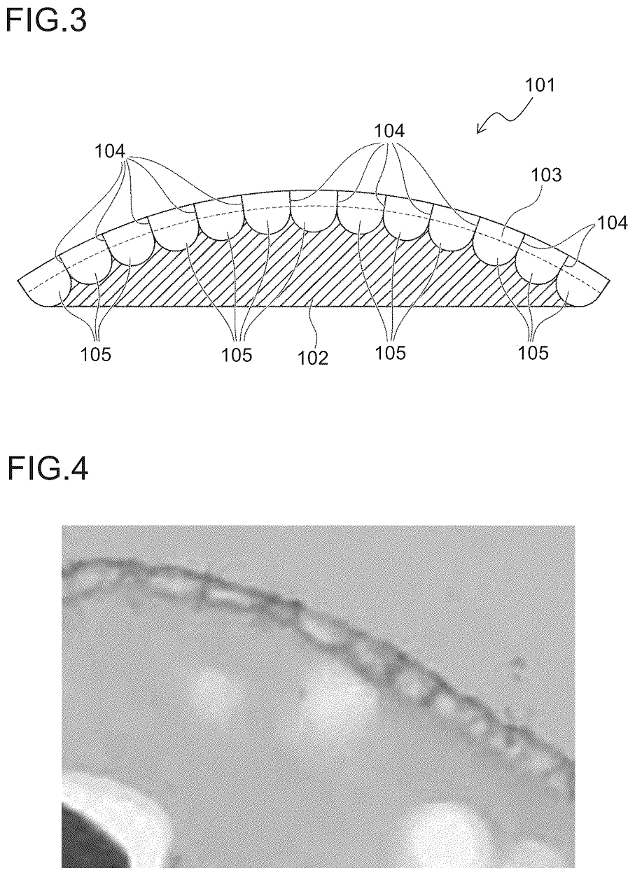

FIG. 3 is a schematic diagram illustrating a part of the cross section of the toner as an appropriate aspect of the present disclosure, observed using the TEM. As illustrated in FIG. 3, in a toner 101, a shell layer 103 coats the entire surface of a toner core particle 102. In addition, the shell layer is formed when resin particulates are adhered to the toner core particle so as to form a resin particulate layer, and the outer surface of the resin particulate layer is smoothed by an external force.

The thickness of the shell layer 103 is not particularly limited within the scope without disturbing the object of the present disclosure, and is preferably 0.03 μm or more and 1 μm or less, and is more preferably 0.04 μm or more and 0.7 μm or less, and is particularly preferably 0.05 μm or more and 0.5 μm or less, and is most preferably 0.05 μm or more and 0.3 μm or less. Note that in the toner of the present disclosure, the shell layer has protrusions, and hence the thickness of the shell layer is not uniform. Therefore, in the claims and the specification of this application, the thickness at the largest thickness part of the shell layer is regarded as “the thickness of the shell layer”.

If the shell layer is too thick, the shell layer is hardly broken by a pressure applied to the toner when the toner is fixed to a recording medium. In this case, the binder resin and releasing agent contained in the toner core particles are not soften or molten promptly, and the toner cannot be fixed to the recording medium in a low temperature region. On the contrary, if the shell layer is too thin, the strength of the shell layer is low. If the shell layer has a low strength, the shell layer may be broken by an impact during transportation or the like, and when the toner is stored at high temperature, the toner easily aggregates due to seeping or the like of the releasing agent to the toner surface through a broken part of the shell layer.

The thickness of the shell layer 103 can be measured by analyzing a TEM image of the cross section of the toner 101 using commercial image analysis software. As the commercial image analysis software, WinROOF (made by Mitani Corporation) or the like can be used.

As illustrated in FIG. 3, in the toner of the present disclosure, the shell layer 103 preferably has protrusions 105 on the interface between the toner core particle 102 and the shell layer 103, each protrusion 105 being between two cracks 104. As the shell layer 103 has the protrusions 105, the contact area between the toner core particle 102 and the shell layer 103 can be increased, compared with the case where the shell layer 103 does not have the protrusions 105. In this way, as the shell layer 103 is provided with the protrusions 105, adhesiveness between the toner core particle 102 and the shell layer 103 is improved, and the shell layer 103 is hardly peeled from the toner core particle 102. For this reason, when the shell layer 103 has the protrusions 105, the toner having good heat-resistant storability can be obtained.

More specifically, the shell layer of the electrostatic latent image developing toner of the present disclosure, which is formed using the resin particulates, is formed by a method including the steps of:
I) allowing the spherical resin particulates to adhere to the surface of the toner core particle, so as not to overlap in the direction perpendicular to the surface of the toner core particle, thereby forming the resin particulate layer coating the entire surface of the toner core particle; and
II) deforming the resin particulates in the resin particulate layer by applying an external force on the outer surface of the resin particulate layer, so as to smooth the outer surface of the resin particulate layer, thereby forming the shell layer.

When observing the surface of the toner of the present disclosure using the scanning electron microscope, the smoothing degree of the shell layer is sufficiently such that a structure derived from the spherical resin particulates, which are used for forming the shell layer, is not observed in the outer surface of the shell layer of the toner particle having a particle diameter of 6 μm or more and 8 μm or less. If the shell layer of the toner having a particle diameter 6 μm or more and 8 μm or less is in this state, the shell layer is formed so as not to expose the surface of the core particle for almost all toner particles contained in the toner. When checking the outer surface of the shell layer using the scanning electron microscope observation, the particle diameter of the toner particle corresponds to a diameter of a circle calculated from a projected area of the toner in the electron microscope image.

In the preferred aspect of the shell layer 103 illustrated in FIG. 3, in the toner 101, the entire surface of the toner core particle 102 is coated with the shell layer 103. In addition, as the shell layer 103 coats the entire surface of the toner core particle 102 in such a manner that the outer surface thereof is smooth, when the toner 101 is stored at high temperature, seeping of the releasing agent or the like to the surface of the toner 101 hardly occurs. Note that depending on the shape of the toner core particle 102, the resin particulates may overlap in the direction perpendicular to the surface of toner core particle 102.

Further in the toner 101, because there are the cracks (gaps) 104 inside the shell layer 103, when the toner 101 is fixed to the recording medium, the pressure applied to the toner 101 easily cause the shell layer 103 to be broken from the cracks 104. In this way, in the toner 101, the binder resin, the releasing agent, and the like contained in the toner core particle 102 are softened or molten promptly, and hence the toner 101 can be easily fixed to the recording medium at low temperature region.

### 4. Materials of Toner

The toner of the present disclosure is constituted of the toner core particle containing at least binder resin, and a shell layer coating the entire surface of the toner core particle. The toner core particle may contain releasing agent, charge controlling agent, coloring agent, magnetic powder, and the like as necessary in the binder resin. In addition, the toner of the present disclosure may have a surface treated with an external additive if desired.

Hereinafter, there are described the binder resin, the releasing agent, the charge controlling agent, the coloring agent, and the magnetic powder, which are essential or arbitrary components of the electrostatic latent image developing toner of the present disclosure, the resin particulates and the external additive forming the shell layer, and a method for producing the electrostatic latent image developing toner of the present disclosure, in order.

### (Binder Resin)

The toner core particle of the toner of the present disclosure contains the binder resin. The binder resin contained in the toner core particle is not particularly limited as long as it is resin that is conventionally used as the binder resin for the toner. As specific examples of the binder resin, there is a thermoplastic resin such as styrene resin, acrylic resin, styrene acrylic resin, polyethylene resin, propylene resin, vinyl chloride resin, polyester resin, polyamide resin, polyurethane resin, polyvinyl alcohol resin, vinyl ether resin, N-vinyl resin, styrene-butadiene resin. Among these resins, polystyrene resin and polyester resin are preferred in view of dispersion property of the coloring agent in the binder resin, electrostatic property of the toner, and fixing performance to the paper sheet. Hereinafter, polystyrene resin and polyester resin are described.

The polystyrene resin may be a homopolymer of styrene, or may be a copolymer with other copolymerization monomer that can copolymerize with styrene. As specific examples of other copolymerization monomer that can copolymerize with styrene, there are p-chlorostyrene; vinylnaphthalene; ethylene unsaturated monoolefins such as ethylene, propylene, butylene, and isobutylene; vinyl halides such as vinyl chloride, vinyl bromide, and vinyl fluoride; vinylesters such as vinyl acetate, vinyl propionate, vinyl benzoate, and vinyl butyrate; (meth)acrylic esters such as methyl acrylate, ethyl acrylate, n-butyl acrylate, isobutyl acrylate, dodecyl acrylate, n-octyl acrylate, 2-chloroethyl acrylate, phenyl acrylate, α-chlormethyl methacrylate, methyl methacrylate, ethyl methacrylate, and butyl methacrylate; other acrylic derivatives such as acrylonitrile, methacrylonitrile, and acrylamide; vinyl ethers such as vinyl methyl ether or vinyl isobutyl ether; vinyl ketones such as vinyl methyl ketone, vinyl ethyl ketone, and methyl isopropenyl ketone; N-vinyl compound such as N-vinyl pyrrole, N-vinyl carbazole, N-vinyl indole, and N-vinyl pyrrolidone. Two or more of these copolymerization monomers can be combined to be copolymerized with the styrene monomer.

The polyester resin to be used can be obtained by condensation polymerization or condensation copolymerization of bivalent or trivalent or higher alcohol component and bivalent or trivalent or higher carboxylic acid component. As the component that is used when synthesizing the polyester resin, there are following alcohol components and carboxylic acid components.

As specific examples of the bivalent or trivalent or higher alcohol component, there are diols such as ethylene glycol, diethylene glycol, triethylene glycol, 1,2-propylene glycol, 1,3-propylene glycol, 1,4-butane diol, neopentyl glycol, 1,4-butene diol, 1,5-pentane diol, 1,6-hexane diol, 1,4-cyclohexane dimethanol, dipropylene glycol, polyethylene glycol, polypropylene glycol, and polytetramethylene glycol; bisphenols such as bisphenol A, hydrogenated bisphenol A, polyoxyalkylene bisphenol A, and polyoxypropylene bisphenol A; and trivalent or higher alcohols such as sorbitol, 1,2,3,6-hexane tetrol, 1,4-sorbitan, pentaerythritol, dipentaerythritol, tripentaerythritol, 1,2,4-butane triol, 1,2,5-pentane triol, glycerol, diglycerol, 2-methylpropane triol, 2-methyl-1,2,4-butane triol, trimethylolethane, trimethylolpropane, and 1,3,5-trihydroxymethylbenzene.

As specific examples of the bivalent or trivalent or higher carboxylic acid component, there are bivalent carboxylic acids such as alkyl or alkenyl succinic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, and n-butyl succinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, isododecenylsuccinic acid; and trivalent or higher carboxylic acids such as 1,2,4-benzene tricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxy propane, 1,2,4-cyclohexane tricarboxylic acid, tetra(methylene carboxyl)methane, 1,2,7,8-octanetetracarboxylic acid, pyromellitic acid, and empoletrimer acid. These bivalent or trivalent or higher carboxylic acid components may be used as an ester forming derivative such as acid halide, acid anhydride, and lower alkyl ester. Here, “lower alkyl” means an alkyl group having 1 to 6 carbon atoms.

In the case where the binder resin is polyester resin, the softening point of the polyester resin is preferably 70° C. or higher and 130° C. or lower, and is more preferably 80° C. or higher and 120° C. or lower.

As the binder resin, it is preferred to use thermoplastic resin, which has good fixing performance to the paper sheet, and it is possible not only to use the thermoplastic resin alone, but also to add cross-linker or thermosetting resin to the thermoplastic resin. By adding cross-linker or thermosetting resin so as to introduce a partial crosslinked structure into the binder resin, heat-resistant storability, durability, or the like of the toner can be improved without deteriorating fixing performance of the toner. Note that when using the thermosetting resin, a crosslinked amount (gel amount) of the binder resin extracted using Soxhlet extractor is preferably 10 mass % or less, and is more preferably 0.1 mass % or more and 10 mass % or less, with respect to mass of the binder resin.

As the thermosetting resin that can be used with the thermoplastic resin, epoxy resin or cyanate resin is preferred. As specific examples of the preferred thermosetting resin, there are bisphenol A type epoxy resin, hydrogenated bisphenol A type epoxy resin, novolac epoxy resin, polyalkylene ether epoxy resin, cycloaliphatic epoxy resin, and cyanate resin. Two or more of these thermosetting resins can be combined for use.

The glass transition temperature (Tg) of the binder resin is preferably 40° C. or higher and 70° C. or lower. If the glass transition temperature is too high, low temperature fixing performance of the toner is apt to decrease. If the glass transition temperature is too low, heat-resistant storability of the toner is apt to decrease.

The glass transition temperature of the binder resin can be determined from a specific heat change point of the binder resin using a differential scanning calorimeter (DSC). More specifically, using the differential scanning calorimeter DSC-6200 made by Seiko Instruments Inc. as a measurement device, an endothermic curve of the binder resin is measured, and thus the glass transition temperature of the binder resin can be determined. The measurement sample of 10 mg is put in an aluminum pan, and a vacant aluminum pan is used as a reference. The glass transition temperature of the binder resin can be determined from the endothermic curve of the binder resin, which is obtained by measurement at a measurement temperature range of 25° C. or higher and 200° C. or lower and a temperature increase rate of 10° C./min, under normal temperature and normal humidity.

The mass average molecular weight (Mw) of the binder resin is not particularly limited in the range that does not inhibit the object of the present disclosure. Typically, the mass average molecular weight (Mw) of the binder resin is preferably 20,000 or more and 3,000,000 or less, and is more preferably 30,000 or more and 2,000,000 or less. Note that the mass average molecular weight of the binder resin can be determined by using a calibration curve, which was created in advance using a standard polystyrene resin, with a gel permeation chromatography (GPC).

In addition, in the case where the binder resin is polystyrene resin, the binder resin preferably has a peak in each of a low molecular region and a high molecular region on a molecular weight distribution measured by the gel permeation chromatography or the like. Specifically, the peak in the low molecular region is preferably in a molecular weight range of 3,000 or more and 20,000 or less, and the peak in the high molecular region is preferably in a molecular weight range of 300,000 or more and 1,500,000 or less. In addition, as to the polystyrene resin having this molecular weight distribution, a ratio (Mw/Mn) between a number average molecular weight (Mn) and the mass average molecular weight (Mw) is preferably 10 or more. When the binder resin has the peak in the low molecular region and the peak in the high molecular region in the above ranges on the molecular weight distribution, it is possible to obtain the toner that has good low temperature fixing performance and can suppress a high temperature offset.

### (Releasing Agent)

The toner core particle preferably contains the releasing agent in purpose of improving the fixing performance and offset resistance. The type of the releasing agent that can be contained in the toner core particle is not particularly limited in the range that does not inhibit the object of the present disclosure. As the releasing agent, wax is preferred, and as example of the wax, there are carnauba wax, synthetic ester wax, polyethylene wax, polypropylene wax, fluorocarbon resin wax, Fischer-Tropsch wax, paraffin wax, montan wax, and rice wax. Two or more of these releasing agents can be combined for use. By adding the releasing agent to the toner, it is possible to more effectively suppress occurrence of the offset or image smearing (staining around image when rubbing the image).

In the case where the polyester resin is used as the binder resin, in view of compatibility, as the releasing agent, one or more releasing agents selected from a group consisting of carnauba wax, synthetic ester wax, and polyethylene wax are used appropriately. In addition, in the case where the polystyrene resin is used as the binder resin, similarly in view of compatibility, as the releasing agent, Fischer-Tropsch wax, and/or paraffin wax are used appropriately.

Note that the Fischer-Tropsch wax is a straight-chain hydrocarbon compound with little iso-structural molecule or side chain produced utilizing a Fischer-Tropsch reaction, which is a catalytic hydrogenation reaction of carbon monoxide.

Among Fischer-Tropsch waxes, it is preferred to use the Fischer-Tropsch wax that has a mass average molecular weight of 1,000 or more, and has an endothermic peak bottom temperature observed by the DSC measurement in a range of 100° C. or higher and 120° C. or lower. As this Fischer-Tropsch wax, there are Sasol wax C1 (having an endothermic peak bottom temperature of 106.5° C.), Sasol wax C105 (having an endothermic peak bottom temperature of 102.1° C.), Sasol wax SPRAY (having an endothermic peak bottom temperature of 102.1° C.), and the like, which are available from Sasol Limited.

A usage amount of the releasing agent is not particularly limited in the range that does not inhibit the object of the present disclosure. A specific usage amount of the releasing agent is preferably 1 mass % or more and 10 mass % or less with respect to total mass of the toner core particles. If the usage amount of the releasing agent is too small, desired effect of suppressing occurrence of the offset or image smearing in a formed image may not be obtained, while if the usage amount of the releasing agent is too large, heat-resistant storability of the toner may be deteriorated due to fusion of toner particles.

### (Charge Controlling Agent)

The toner core particle may contain the charge controlling agent, in purpose of improving the charging level of the toner or charging rise characteristics as an indication whether or not charging to a predetermined charging level can be attained in a short time, so as to obtain the toner having good durability and stability. When giving a positive charge to the toner for development, the charge controlling agent having positive electrostatic property is used, while when giving a negative charge to the toner for development, the charge controlling agent having negative electrostatic property is used.

The type of the charge controlling agent that can be contained in the toner core particle is not particularly limited in the range that does not inhibit the object of the present disclosure, and it is possible to use one selected appropriately from the charge controlling agents that are conventionally used for toner. As specific examples of the charge controlling agent having positive electrostatic property, there are azine compounds such as pyridazine, pyrimidine, pyrazine, orthooxazine, methoxazine, paraoxazine, orthothiazine, methathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes made of azine compounds such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salt, and nigrosine derivative; acid dyes made of nigrosine compounds such as nigrosine BK, nigrosine NB, and nigrosine Z; metal salts of naphthene acid or higher fatty acid; alkoxylated amine; alkylamide; and quaternary ammonium salts such as benzylmethylhexyldecyl ammonium, and decyltrimethylammonium chloride. Among these charge controlling agents having positive electrostatic property, nigrosine compound is particularly preferred because more rapid charging rise characteristics can be obtained. Two or more of these the charge controlling agents having positive electrostatic property can be combined for use.

A resin having quaternary ammonium salt, carboxylic acid salt, and a carboxyl group as a functional group can also be used as the charge controlling agent having positive electrostatic property. More specifically, there are styrene resin having quaternary ammonium salt, acrylic resin having quaternary ammonium salt, styrene-acrylic resin having quaternary ammonium salt, polyester resin having quaternary ammonium salt, styrene resin having carboxylic acid salt, acrylic resin having carboxylic acid salt, styrene-acrylic resin having carboxylic acid salt, polyester resin having carboxylic acid salt, styrene resin having carboxyl group, acrylic resin having carboxyl group, styrene-acrylic resin having carboxyl group, and polyester resin having carboxyl group. The molecular weight of these resins is not particularly limited in the range that does not inhibit the object of the present disclosure, and they may be an oligomer, or may be a polymer.

Among the resins that can be used as the charge controlling agent having positive electrostatic property, styrene-acrylic resin having quaternary ammonium salt as a functional group is more preferred, because the charge amount can be easily adjusted to be a value in a desired range. As to styrene-acrylic resin having quaternary ammonium salt as a functional group, as specific examples of acrylic comonomer preferred for copolymerization with a styrene unit, there is (metha)acrylic alkylester such as methyl acrylate, ethyl acrylate, n-propyl acrylate, iso-propyl acrylate, n-butyl acrylate, iso-butyl acrylate, 2-ethylhexyl acrylate, methamethyl acrylate, methaethyl acrylate, n-butyl methacrylate, and iso-butyl methacrylate.

In addition, as quaternary ammonium salt, a unit derived from dialkylaminoalkyl (metha)acrylate, dialkyl (metha)acrylamide, and dialkylaminoalkyl (metha)acrylamide via a quaternization step is used. As specific examples of dialkylaminoalkyl (metha)acrylate, there are dimethylaminoethyl (metha)acrylate, diethylaminoethyl (metha)acrylate, dipropylaminoethyl (metha)acrylate, and dibutylaminoethyl (metha)acrylate. As specific examples of dialkyl (metha)acrylamide, there is dimethyl methacrylamide, and as specific examples of dialkylaminoalkyl (metha)acrylamide, there is dimethyl aminopropyl methacrylamide. In addition, it is also possible to combine and use polymerizable monomer containing hydroxy group such as hydroxy ethyl (metha)acrylate, hydroxy propyl (metha)acrylate, 2-hydroxy butyl (metha)acrylate, and N-methylol (metha)acrylamide, when polymerization is performed.

As specific examples of the charge controlling agent having negative electrostatic property, there are, for example, organic metal complex, chelate compound, monoazo metal complex, acetylacetone metal complex, aromatic hydroxy carboxylic acid, aromatic dicarboxylic acid metal complex, aromatic monocarboxylic acid, and aromatic polycarboxylic acid, and metal salt thereof, anhydride, esters, and phenol derivatives such as bisphenol. Among them, organic metal complex and chelate compound are preferred. As organic metal complex and chelate compound, acetylacetone metal complex such as aluminum acetylacetonato or iron (II) acetylacetonato, and salicylic acid metal complex such as 3,5-di-tert-butylsalicylic acid chromium or salicylic acid metal salt are more preferred, and salicylic acid metal complex or salicylic acid metal salt are particularly preferred. Two or more of these charge controlling agents having negative electrostatic property can be combined for use.

The usage amount of the charge controlling agent having positive electrostatic property or negative electrostatic property is not particularly limited in the range that does not inhibit the object of the present disclosure. It is preferred that the usage amount of the charge controlling agent having positive electrostatic property or negative electrostatic property is typically 0.1 mass % or more and 10 mass % or less, with respect to the entire mass of the toner core particles. If the usage amount of the charge controlling agent is too small, the toner can hardly be charged stably at a predetermined polarity, and hence image density of the formed image may be below a desired value, or it may be difficult to maintain image density for a long period of time. In addition, because the charge controlling agent can hardly be dispersed uniformly, a fog may easily occur in the formed image, or contamination of a latent image carrier due to the toner component may easily occur. If the usage amount of the charge controlling agent is too large, environment resistance is deteriorated, which may easily cause poor image quality of the formed image due to poor charging at high temperature and high humidity, or contamination of the latent image carrier due to the toner component.

### (Coloring Agent)

The toner core particle may contain the coloring agent as necessary. As the coloring agent that can be contained in the toner core particle, known pigment or dye can be used in accordance with a color of the toner. As specific examples of the preferred coloring agent that can be added to the toner, there are black color pigments such as carbon black, acethylene black, lampblack, and aniline black; yellow color pigments such as chrome yellow, zinc yellow, cadmium yellow, yellow color iron oxide, mineral fast yellow, nickel titanium yellow, naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazoyellow; orange color pigments such as orange chrome yellow, molybdate orange, permanent orange GTR, pyrazolone orange, Balkan orange, and Indaslen brilliant orange GK; red color pigments such as Indian red, cadmium red, saturn red, mercury sulfide cadmium, permanent red 4R, Lithol red, pyrazolone red, watching red calcium salt, lake red D, brilliant carmine 6B, eosin lake, rhodamine lakeB, alizarin lake, brilliant carmine 3B, and monoazo red; violet color pigments such as manganese violet, fast violet B, and methylviolet lake; blue color pigments such as iron blue, cobalt blue, alkali blue lake, Victoria blue partial chlorination product, fast sky blue, Indaslen blueBC, and phthalocyanine blue; green color pigments such as chromium green, chromium oxide, pigment green B, malachite green lake, and final yellow green G; white color pigments such as hydrozincite, titanium oxide, antimony white, and zinc sulfide; and body pigments such as baryta powder, barium carbonate, clay, silica, white carbon, talc, and alumina white. It may be possible to combine two or more of these coloring agents for use in purpose of adjusting the toner to have a desired hue.

The usage amount of the coloring agent is not particularly limited in the range that does not inhibit the object of the present disclosure. Specifically, the usage amount of the coloring agent is preferred to be 1 mass % or more and 10 mass % or less with respect to the entire mass of the toner core particle, and is more preferred to be 2 mass % or more and 7 mass % or less.

Note that it is possible to use the coloring agent as a masterbatch in which the coloring agent is dispersed in advance in resin such as thermoplastic resin. When using the coloring agent as a masterbatch, the resin contained in the masterbatch is preferably the same type of resin as the binder resin.

### (Resin Particulates)

The shell layer in the electrostatic latent image developing toner of the present disclosure is made of resin containing the charge controlling resin. In addition, the shell layer is made of resin particulates. For this reason, as the resin particulates used for forming the shell layer, resin particulates made of resin containing the charge controlling resin is used. As the shell layer is made of resin containing the charge controlling resin, when images are formed in various environment such as high temperature and high humidity environment or low temperature and low humidity environment for a long time, the toner can be charged at a desired charge amount, and desired density of images can be formed.

In order to easily form the shell layer having a predetermined structure, the material of the resin particulates is preferably a polymer of monomers having unsaturated bonds. Further, the charge controlling resin is preferably a copolymer of a monomer that has an electrostatic property functional group giving electrostatic property to the resin and the unsaturated bond, and a monomer that does not have the electrostatic property functional group but has the unsaturated bond. As the monomer having the electrostatic property functional group and the unsaturated bond, which is used for giving positive electrostatic property to the resin, a monomer that has a nitrogen-containing polarity functional group such as a quaternized ammonium group and the unsaturated bond is preferred. On the other hand, as the monomer having the electrostatic property functional group and the unsaturated bond, which is used for giving negative electrostatic property to the resin, a monomer that has a fluorine-substituted hydrocarbon group or a sulfo group and the unsaturated bond is preferred.

The type of the monomer having unsaturated bond is not particularly limited, as long as it can synthesize a resin having sufficient physical property for the shell layer. As the monomer having unsaturated bond, vinyl monomer is preferred. In the vinyl group contained in the vinyl monomer, the alpha position may be substituted with alkyl group. In addition, the vinyl group contained in the vinyl monomer may be substituted with a halogen atom. The alkyl group that can be contained in the vinyl group is preferably an alkyl group having 1 to 6 carbon atoms, and is more preferably a methyl group or an ethyl group, and is particularly preferably a methyl group. In addition, the halogen atom that can be contained in the vinyl group is preferably a chlorine atom or a bromine atom, and is more preferably a chlorine atom.

Among vinyl monomers, as specific examples of the monomer that does not have the electrostatic property functional group, such as a nitrogen-containing polarity functional group, a fluorine-substituted hydrocarbon group, and a sulfo group, there are styrenes such as styrene, o-methylstyrene, m-methylstyrene, p-methylstyrene, p-ethylstyrene, 2,4-dimethylstyrene, p-n-butyl styrene, p-tert-butylstyrene, p-n-hexylstyrene, p-n-octylstyrene, p-n-nonylstyrene, p-n-decylstyrene, p-n-dodecylstyrene, p-methoxystyrene, p-ethoxystyrene, p-phenylstyrene, p-chlorostyrene, and 3,4-dichlorostyrene; ethylene unsaturated monoolefins such as ethylene, propylene, butylene, and isobutylene; vinyl halides such as vinyl chloride, vinylidene chloride, vinyl bromide, and vinyl fluoride; vinyl esters such as vinyl acetate, vinyl propionate, vinyl benzoate, and vinyl butyrate; (metha)acrylic esters such as methyl (metha)acrylate, ethyl (metha)acrylate, n-butyl (metha)acrylate, isobutyl (metha)acrylate, propyl (metha)acrylate, n-octyl (metha)acrylate, dodecyl (metha)acrylate, 2-ethylhexy (metha)acrylate, stearyl (metha)acrylate, 2-chloroethyl (metha)acrylate, phenyl (metha)acrylate, and α-chloromethyl acrylate; (metha)acrylic derivatives such as acrylonitrile; vinyl ethers such as vinyl methyl ether, vinyl ethylether, and vinyl isobutyl ether; vinyl ketones such as vinyl methyl ketone, vinyl hexylketone, and methyl isopropenyl ketone; and vinyl naphthalines. Among them, styrenes is preferred, and styrene is more preferred. Two or more of these monomers can be combined for use.

As examples of the vinyl monomer having the nitrogen-containing polarity functional group as the positive electrostatic property functional group, which is used as the monomer of the charge controlling resin having positive electrostatic property, there are N-vinyl compound, amino (metha)acrylic monomer, and methacrylonitrile (metha)acrylamide. As specific examples of the N-vinyl compound, there are N-vinyl compounds such as N-vinyl pyrrole, N-vinyl carbazole, N-vinyl indole, and N-vinyl pyrolidone. In addition, as preferred examples of the amino (metha)acrylic monomer, there are compounds expressed by the following formula.

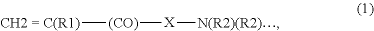

where, R1 is hydrogen atom or a methyl group. R2 and R3 are each a hydrogen atom or an alkyl group having 1 to 20 carbon atoms. X represents —O—, —O-Q-, or —NH. Q is an alkylene group having 1 to 10 carbon atoms, a phenylene group, or a combination thereof.

In the above formula (1), as specific examples of R2 and R3, there are a methyl group, an ethyl group, an n-propyl group, an iso-propyl group, an n-butyl group, an iso-butyl group, a sec-butyl group, a tert-butyl group, an n-pentyl group, an iso-pentyl group, a tert-pentyl group, an n-hexyl group, an n-heptyl group, an n-octyl group, a 2-ethylhexyl group, an n-nonyl group, an n-decyl group, an n-undecyl group, an n-dodecyl group (a lauryl group), an n-tridecyl group, an n-tetradecyl group, an n-pentadecyl group, an n-hexadecyl group, an n-heptadecyl group, an n-oktadecyl group (a stearyl group), an n-nonadecyl group, and an n-icosyl group.

In the above formula (1), as specific examples of Q, there are a methylene group, a 1,2-ethane-diyl group, a 1,1-ethylene group, a propane-1,3-diyl group, a propane-2,2-diyl group, a propane-1,1-diyl group, a propane-1,2-diyl group, a butane-1,4-diyl group, a pentane-1,5-diyl group, a hexane-1,6-diyl group, a heptan-1,7-diyl group, an octane-1,8-diyl group, a nonan-1,9-diyl group, a decane-1,10-diyl group, a p-phenylene group, an m-phenylene group, an o-phenylene group, and a bivalent group obtained by eliminating hydrogen from 4-position of the phenyl group contained in the benzylbenzyl group.

As specific examples of the amino (metha)acrylic monomer expressed by the above formula, for example, there are N,N-dimethylamino (metha)acrylate, N,N-dimethylaminomethyl (metha)acrylate, N,N-diethylaminomethyl (metha)acrylate, 2-(N,N-methylamino) ethyl (metha)acrylate, 2-(N,N-diethylamino) ethyl (metha)acrylate, 3-(N,N-dimethylamino) propyl (metha)acrylate, 4-(N,N-dimethylamino) butyl (metha)acrylate, p-N,N-dimethylaminophenyl (metha)acrylate, p-N,N-diethylaminophenyl (metha)acrylate, p-N,N-dipropylaminophenyl (metha)acrylate, p-N,N-di-n-butyl aminophenyl (metha)acrylate, p-N-laurylaminophenyl (metha)acrylate, p-N-stearylaminophenyl (metha)acrylate, (p-N,N-dimethylaminophenyl) methyl (metha)acrylate, (p-N,N-diethylaminophenyl) methyl (metha)acrylate, (p-N,N-di-n-propylaminophenyl) methyl (metha)acrylate, (p-N,N-di-n-butyl aminophenyl) methylbenzyl (metha)acrylate, (p-N-laurylaminophenyl) methyl (metha)acrylate, (p-N-stearylaminophenyl) methyl (metha)acrylate, N,N-dimethylaminoethyl (metha)acrylamide, N,N-diethylaminoethyl (metha)acrylamide, 3-(N,N-dimethylamino) propyl (metha)acrylamide, 3-(N,N-diethylamino) propyl (metha)acrylamide, p-N,N-dimethylaminophenyl (metha)acrylamide, p-N,N-diethylaminophenyl (metha)acrylamide, p-N,N-di-n-propylaminophenyl (metha)acrylamide, p-N,N-di-n-butyl aminophenyl (metha)acrylamide, p-N-laurylaminophenyl (metha)acrylamide, p-N-stearylaminophenyl (metha)acrylamide, (p-N,N-dimethylaminophenyl) methyl (metha)allylamide, (p-N,N-diethylaminophenyl) methyl (metha)acrylamide, (p-N,N-di-n-propylaminophenyl) methyl (metha)acrylamide, (p-N,N-di-n-butyl aminophenyl) methyl (metha)acrylamide, (p-N-laurylaminophenyl) methyl (metha)acrylamide, and (p-N-stearylaminophenyl) methyl (metha)acrylamide.

As examples of the vinyl monomer having the fluorine-substituted hydrocarbon group as the negative electrostatic property functional group, which is used as the monomer of the charge controlling resin having negative electrostatic property, there are fluoroalkyl (metha)acrylates such as 2,2,2-trifluoroethylacrylate, 2,2,3,3-tetrafluoropropylacrylate, 2,2,3,3,4,4,5,5-oktafluoroamylacrylate, and 1H,1H,2H,2H-heptadecafluorodecylacrylate, trifluorochloroethylene, vinylidene fluoride, ethylene trifluoride, ethylene tetrafluoride, trifluoropropylene, hexafluoropropene, hexafluoropropylene, and the like. Among them, fluoroalkyl (metha)acrylates are preferred.

As examples of the vinyl monomer having the sulfo group as the negative electrostatic property functional group, which is used as the monomer of the charge controlling resin having negative electrostatic property, there are 2-acrylamide-2-methylpropane sulfonic acid; styrene sulfonic acid sodium; sulfoalkyl (metha)acrylic monomers such as sulfoethyl acrylic acid, sulfoethyl methacrylic acid, and sulfoethyl methacrylic acid sodium. Among them, 2-acrylamide-2-methylpropane sulfonic acid is preferred.

An addition polymerization method of the monomer having unsaturated bond is not limited in the range that does not inhibit the object of the present disclosure, it is possible to select an arbitrary method such as solution polymerization, bulk polymerization, emulsion polymerization, or suspension polymerization.

As a polymerization initiator that can be used for polymerization of the vinyl monomer described above, it is possible to use known polymerization initiators such as potassium persulfate, sodium peroxodisulfate, tassium peroxodisulfate, ammonium peroxodisulfate, acetyl peroxide, decanoyl peroxide, lauroyl peroxide, benzoyl peroxide, azobis isobutyronitrile, azobis methylbutyronitrile, 2,2′-azobis-2,4-dimethylvaleronitrile, 2,2′-azobis-4-methoxy-2,4-dimethylvaleronitrile, t-butylperoxyacyl-2-ethylhexanoate, t-butyl perbenzoate, dicyclohexylperoxide, and dicumylperoxide. The usage amount of the polymerization initiator is preferably 0.1 mass % or more and 15 mass % or less with respect to a total mass of the monomers.

A polymerization method of the above vinyl monomer is not limited in the range that does not inhibit the object of the present disclosure, and it is possible to select an arbitrary method such as solution polymerization, bulk polymerization, emulsion polymerization, suspension polymerization, or the like.

When performing addition polymerization of the monomer having unsaturated bond using aqueous medium, like emulsion polymerization or suspension polymerization, it is possible to use a surface acting agent. The surface acting agent is not limited in the range that does not inhibit the object of the present disclosure, and it is possible to appropriately select from a group consisting of anionic surface acting agents, cationic surface acting agents, and nonionic surface acting agents. As examples of the anionic surface acting agent, there are sulfate ester salt type activators, sulfonic acid salt type activators, phosphate ester salt type surface acting agents, and soap. As examples of the cationic surface acting agent, there are amine salt type activators, and quaternary ammonium salt type activators. As examples of the nonionic surface acting agent, there are polyethylene glycol type activators, alkylphenol ethylene oxide adduct type activators, and polyalcohol type activators as a derivative of polyalcohol such as glycerin, sorbitol, or sorbitan. Among these surface acting agents, it is preferred to use at least one of the anionic surface acting agent and the nonionic surface acting agent. One of these surface acting agents may be used, or two or more of these surface acting agents may be combined for use.

In the case where the charge controlling resin is a copolymer of the monomer having the electrostatic property functional group that gives electrostatic property to the resin and the unsaturated bond, and the monomer that does not have the electrostatic property functional group but has the unsaturated bond, a mole ratio of a constitutional unit derived from the monomer having electrostatic property functional group and the unsaturated bond in the charge controlling resin, with respect to all constitutional units of the charge controlling resin, is preferably 0.1 mol % or more and 10 mol % or less, and is more preferably 0.3 mol % or more and 7 mol % or less.

The contained amount of the charge controlling resin in the resin forming the resin particulates is not particularly limited in the range that does not inhibit the object of the present disclosure. The contained amount of the charge controlling resin in the resin as material of the resin particulates is preferably 80 mass % or more, and is more preferably 90 mass % or more, and is particularly preferably 100 mass %, with respect to the entire mass of the resin particulates. In the case where the resin forming the resin particulates is a mixture of the charge controlling resin and resin that does not have the electrostatic property functional group, as the resin that does not have the electrostatic property functional group, it is possible to use a polymer of one or more monomers selected from the above vinyl monomers that do not have the electrostatic property functional group. In addition, the resin particulates may be prepared using the resin containing the above coloring agent, as necessary.

The mixture of the charge controlling resin and the resin that does not have the electrostatic property functional group can be prepared by a method of melting and kneading two or more resins using a melt-kneading device such as a twin-screw extruder, or a method of dissolving two or more resins in an organic solvent, and removing the organic solvent from the obtained resin solution.

In addition, it may be possible to combine and use the resin particulates made of the resin containing the charge controlling resin with the resin particulates made of the resin that does not have the electrostatic property functional group, so as to form the shell layer. In this case, a mass ratio of the resin particulates made of the resin containing the charge controlling resin, with respect to the total mass of the resin particulates used for forming the shell layer, is preferably 80 mass % or more, and is more preferably 90 mass % or more. In this case, as the resin particulates made of the resin that does not have the electrostatic property functional group, it is possible to use resin particulates made of a polymer of one or more monomers selected from the above vinyl monomers that do not have the electrostatic property functional group.

The glass transition temperature of the resin forming the resin particulates is not particularly limited in the range that does not inhibit the object of the present disclosure. Typically, the glass transition temperature is preferably 45° C. or higher and 90° C. or lower, and is more preferably 50° C. or higher and 80° C. or lower. In addition, the softening point of the resin forming the resin particulates is not particularly limited in the range that does not inhibit the object of the present disclosure. Typically, the softening point is preferably 100° C. or higher and 250° C. or lower, and is more preferably 110° C. or higher and 240° C. or lower. In addition, the softening point of the resin is preferably higher than the softening point of the binder resin contained in the toner core particle, and is more preferably higher by 10° C. or more and 140° C. or less. As the temperature characteristics of the resin forming the resin particulates are in the above range, when the resin particulates are embedded in the toner core particle, part of the resin particulates that contact the toner core particle are hardly deformed, and the protrusions derived from the shape of the resin particulates before changing to the shell layer can be easily formed on the inner surface of the shell layer.

The mass average molecular weight (Mw) of the resin forming the resin particulates is not particularly limited in the range that does not inhibit the object of the present disclosure. Typically, the mass average molecular weight is preferably 20,000 or more and 1,500,000 or less, and is more preferably 200,000 or more and 400,000 or less. The mass average molecular weight (Mw) of the resin as the material of the resin particulates can be measured by gel permeation chromatography using a conventionally known method.

The average particle size of the resin particulates is not particularly limited in the range that does not inhibit the object of the present disclosure, and is preferably 0.03 μm or more and 1 μm or less, and is more preferably 0.04 μm or more and 0.7 μm or less, and is particularly preferably 0.05 μm or more and 0.5 μm or less, and is most preferably 0.05 μm or more and 0.3 μm or less. When using the resin particulates having the above particle diameter, the surface of the toner core particle can be uniformly coated with the resin particulates to be a single layer, and the shell layer having a desired structure can be easily formed. If the average particle size of the resin particulates is too small, the shell layer having a preferred thickness can be hardly formed on the surface of the toner core particle, and the toner having good heat-resistant storability can be hardly obtained. On the contrary, if the average particle size of the resin particulates is too large, the resin particulates cannot uniformly adhere to the surface of the toner core particle. For this reason, the shell layer having a predetermined structure is hardly formed, and the toner having good heat-resistant storability can be hardly obtained.

The average particle size of the resin particulates can be adjusted by adjusting polymerization conditions or a known crushing method, classifying method, or the like. As to the average particle size of the resin particulates, particle diameters of 50 or more resin particulates are measured by an electron microscope picture captured using a field emission scanning electron microscope (JSM-6700F made by JEOL Ltd.), so that the number average particle size can be measured.

The usage amount of the resin particulates is not particularly limited in the range that does not inhibit the object of the present disclosure. Typically, the usage amount of the resin particulates is preferably 1 mass part or more and 20 mass parts or less, and is more preferably 3 mass parts or more and 15 mass parts or less, with respect to 100 mass parts of the toner core particles. If the usage amount of the resin particulates is too small, the resin particulates may not be able to coat the entire surface of the toner core particle. If the entire surface of the toner core particle cannot be coated with the resin particulates, the toner is easily agglomerated when it is stored at high temperature, and the heat-resistant storability is easily deteriorated. If the usage amount of the resin particulates is too large, the thickness of the shell layer is easily increased. In this case, it is difficult to obtain the toner having good fixing performance.

### (External Additive)

The toner of the present disclosure can be treated with an external additive, if desired, after the shell layer is formed on the surface of the toner core particle. Hereinafter, the particle that is treated with the external additive is also referred to as a “toner mother particle”.

The type of the external additive is not particularly limited in the range that does not inhibit the object of the present disclosure, and can be appropriately selected from external additives that are conventionally used for toner. As specific examples of the appropriate external additive, there are metal oxides such as silica, alumina, titanium oxide, magnesia oxide, zinc oxide, strontium titanate, and barium titanate. Two or more of these external additives can be combined for use.

The particle diameter of the external additive is not particularly limited in the range that does not inhibit the object of the present disclosure, and is typically and preferably 0.01 μm or more and 1.0 μm or less.

The usage amount of the external additive is not particularly limited in the range that does not inhibit the object of the present disclosure. The usage amount of the external additive is typically and preferably 0.1 mass % or more and 10 mass % or less, and is more preferably 0.2 mass % or more and 5 mass % or less, with respect to the entire mass of the toner mother particle produced with the shell layer formed on the surface of the toner core particle. If the usage amount of the external additive is too small, hydrophobic property of the toner is easily deteriorated. As a result, it is easily affected by water molecules in the air in high temperature and high humidity environment, and an extreme decrease of the charge amount of the toner may easily cause problems such as a decrease in image density of the formed image, a decrease in flowability of the toner, and the like. In addition, if the usage amount of the external additive is too large, excessive charge-up of the toner may cause a decrease in image density.

### 5. Method for Producing Non-Magnetic One-Component Developing Toner

A method for producing the electrostatic latent image developing toner described above is not particularly limited, as long as the toner core particles and the shell layer are formed to each have a predetermined structure. In addition, if necessary, the toner core particle coated with the shell layer may be used as the toner mother particle, so as to perform an external addition treatment for allowing the external additive to adhere to the surface of the toner mother particle. As an appropriate method for producing the electrostatic latent image developing toner described above, a method for producing the toner core particles, a method for forming the shell layer, and a method for the external addition treatment are described in turn as follows.

### (Method for Producing Toner Core Particles)

The method for producing the toner core particles is not particularly limited, as long as arbitrary components such as the coloring agent, the releasing agent, the charge controlling agent, and the magnetic powder can be dispersed well in the binder resin. As specific examples of an appropriate method for producing the toner core particles, there is a method of mixing the binder resin with components such as the coloring agent, the releasing agent, the charge controlling agent, and the magnetic powder, using a mixer or the like, melting and kneading the binder resin and the components mixed to the binder resin using a kneading machine such as a single or twin-screw extruder, and crushing and classifying the kneaded material after cooling. The average particle size of the toner core particle is not particularly limited in the range that does not inhibit the object of the present disclosure, and is usually and preferably 5 μm or more and 10 μm or less.

### (Method for Forming Shell Layer)

The shell layer is formed using the spherical resin particulates. More specifically, it is formed by the method including:
I) allowing the spherical resin particulates to adhere to the surface of the toner core particle, so as not to overlap in the direction perpendicular to the surface of the toner core particle, thereby forming the resin particulate layer that coats the entire surface of the toner core particle; and
II) applying an external force on the outer surface of the resin particulate layer, so as to deform the resin particulates in the resin particulate layer, thereby smoothing the outer surface of the resin particulate layer so as to form the shell layer.

In this way, as the method for forming the shell layer using the resin particulates, it is preferred to use a method using a mixing device capable of mixing the toner core particles and the resin particulates in a dry condition. As a specific example, there is a method of forming the shell layer on the surface of the toner core particle using a mixing device, which can allow the resin particulates to adhere to the surface of the toner core particle and can apply a mechanical external force on the toner core particle having the surface adhered with the resin particulates. As the mechanical external force, there is a shearing force applied on the toner core particles, due to a friction between the toner core particles or a friction between the toner core particle and an inner wall, a rotor, or a stator of the mixing device, when the toner core particles move at high speed in a narrow space inside the device, and an impact force applied on the toner core particles due to a collision between the toner core particles or a collision between the toner core particle and the inner surface or the like of the device.

More specific method is described. First, in the mixing device, the toner core particles and the resin particulates are mixed, so as to allow the resin particulates to uniformly adhere to the surface of the toner core particle, in such a manner that the resin particulates do not overlap in the direction perpendicular to the surface of the toner core particle. When the toner core particle having a large particle diameter and the resin particulate having a small particle diameter contact each other, a surface contact occurs between the surface of the toner core particle that is microscopically regarded as a flat surface and the surface of the resin particulate, and the resin particulate easily adhere to the toner core particle. In contrast, when the resin particulates contact each other, curved surfaces of the two resin particulates contact each other, and hence a point contact occurs. For this reason, even if another resin particulate adheres to the resin particulate that is adhered to the surface of the toner core particle, during the step of allowing the resin particulates to adhere to the toner core particle, the another resin particulate adhering to the resin particulate is easily peeled from the resin particulate, due to the mechanical external force applied from the mixing device to the toner core particle with the adhered resin particulates. For this reason, in the method described below, the toner core particle is coated with the resin particulates, in such a manner that the resin particulates do not overlap in the direction perpendicular to the surface of the toner core particle.

When allowing the resin particulates to adhere to the toner core particle, the mechanical external force described above is applied on the resin particulate layer on the surface of the toner core particle. When the mechanical external force is applied on the resin particulate layer on the surface of the toner core particle, the resin particulates are embedded in toner core particle and are deformed, and the outer surface of the resin particulate layer coating the entire surface of the toner core particle is smoothed, thereby the resin particulate layer is changed to the shell layer. In this way, the outer surface of the shell layer is smoothed, while the boundary surface between the resin particulates is remained inside the shell layer. For this reason, the cracks in a direction substantially perpendicular to the surface of the toner core particle are formed inside the shell layer formed of the resin particulates.

In this case, if the material of the toner core particle has the same hardness or a little harder than the resin particulates forming the shell layer material, the inner surface of the shell layer (the surface on the toner core particle side) may be smoothed. In contrast, if the material of the toner core particle is softer than the resin particulates forming the shell layer, when the resin particulates are embedded in the toner core particle, the resin particulates are hardly deformed at the parts contacting the toner core particle, and hence the protrusions derived from the shape of the resin particulates before changing to the shell layer are easily formed in the inner surface of the shell layer. Note that in this case, the protrusion is formed between the two cracks of the shell layer.

In the method described above, if the mechanical external force is weak, a desired degree of deformation of the resin particulate does not occur, and there may be a case where the shell layer having a predetermined shape cannot be formed. Depending on the device that is used for forming the shell layer, the condition for forming the shell layer having a predetermined shape are different, and it is possible to determine the appropriate condition for various devices to form the predetermined shell layer, by changing the operation condition step by step, so as to increase the mechanical external force applied on the toner core particle coated with the resin particulates, and by checking a structure of the shell layer of the toner obtained by each condition. However, if the mechanical external force is too strong, for example, the resin particulates are deformed too largely, which may cause problems such that the cracks in a direction substantially perpendicular to the toner core particle are not formed inside the shell layer, or the mechanical external force is converted into heat so as to melt the toner core particle or the resin particulates.

As the device that can coat the toner core particle with the resin particulates, and can apply the mechanical external force on the toner core particle coated with the resin particulates, for example, there are a hybridizer NHS-1 (made by Nara Machinery Co., Ltd.), Cosmos System (made by Kawasaki Heavy Industries, Ltd.), Henschel mixer (made by Nippon Coke & Engineering Co., Ltd.), Multipurpose Mixer (made by Nippon Coke & Engineering Co., Ltd.), Kompoji (made by Nippon Coke & Engineering Co., Ltd.), Mechanofusion Device (made by Hosokawa Micron Corporation), Mechano Mill (made by Okada Seiko Co., ltd.), Nobilta (made by Hosokawa Micron Corporation), and the like.

### (External Addition Treatment Method)

The treatment method of the toner mother particles using external additive is not particularly limited, and the toner mother particles can be treated by a conventionally known method. Specifically, the treatment condition is adjusted so that particles of the external additive are not embedded in the toner mother particle, and the toner mother particles are treated with the external additive using a mixer such as the Henschel mixer or a Nauta mixer.

The above electrostatic latent image developing toner of the present disclosure has good fixing performance and good heat-resistant storability, and when images are formed for a long period of time in various environment such as high temperature and high humidity environment or low temperature and low humidity environment, the toner can be charged at a desired charge amount, and hence an image having a desired density can be formed. For this reason, the electrostatic latent image developing toner of the present disclosure can be used appropriately in various image forming apparatuses. Hereinafter, the effects of the present disclosure are described in more detail with reference to Examples. Note that the present disclosure is not limited at all by the Examples.

### EXAMPLES

### Production Example 1

### (Production of Polyester Resin a, b)

The propyleneoxide adduct of bisphenol A of 1960 g, the ethylene oxide adduct of bisphenol A of 780 g, the dodecenyl anhydrous succinic acid of 257 g, the terephthalic acid of 770 g, and the dibutyltin oxide of 4 g were put in a reaction container. Next, nitrogen atmosphere was formed inside the reaction container, and the temperature inside the reaction container was increased to 235° C. while stirring. Next, the reaction was continued at the temperature for 8 hours, and then the pressure inside the reaction container was decreased to 8.3 kPa so as to continue the reaction for 1 hour. After that, the reaction mixture was cooled to 180° C., and trimellitic acid anhydride was added into the reaction container for desired oxidation. Next, the temperature of the reaction mixture was increased to 210° C. at a rate of 10° C./hour, so as to perform the reaction at the temperature. After the reaction was finished, the contents in the reaction container was taken out and cooled, and the polyester resin a was obtained. In addition, the preparation condition of the above amorphous polyester resin a was appropriately changed, so as to obtain the amorphous polyester resin b having a different mass average molecular weight.

### Production Example 2

### (Production of Toner Core Particles)

The binder resin (the polyester resin obtained in the production example 1) of 89 mass parts, the releasing agent (polypropylene wax 660P made by Sanyo Chemical Industries, Ltd.) of 5 mass parts, the charge controlling agent (P-51 made by Orient Chemical Industries) of 1 mass part, and the coloring agent (carbon black MA100 made by Mitsubishi Chemical Corporation) of 5 mass parts were mixed by a mixer, so as to obtain a mixture. Next, the mixture was melted and kneaded by the twin-screw extruder so as to obtain kneaded material. The kneaded material was roughly crushed by a crusher (Rotoplex made by TOA Machinery Mfg. Co., Ltd.), and then the roughly crushed material was finely crushed by a mechanical crusher (Turbo mill made by Turbo Industry) so as to obtain finely crushed material. The finely crushed material was classified using a classifier (Elbow Jet made by Nittetsu Mining Co., Ltd.) so as to obtain toner core particles having a volume average particle size (D50) of 7.0 μm. The volume average particle size of the toner core particles was measured using a coulter counter (Multisizer 3 made by Beckman Coulter, Inc.).

### Production Example 3

### (Production Resin Particulates A)

A flask having a volume of 2000 mL, equipped with a stirring device, a temperature gage, a cooling pipe, and a nitrogen introduction tube, was used as the reaction container. As the solvent, isobutanol of 180 g was put in the reaction container, and then diethylaminoethylmethacrylate of 16 g and methyl p-toluenesulfonate of 16 g were put in the reaction container. The reaction container was placed on a mantle heater, and nitrogen gas was introduced into the reaction container through the nitrogen introduction tube, so that inactive gas atmosphere was formed inside the reaction container. Next, the mixture in the flask was stirred at a stirring rate of 100 rpm while the temperature inside the reaction container was increased to 80° C., and at this temperature, the stirring at a stirring rate of 100 rpm was continued for 1 hours, so as to perform a quaternization reaction.

After the quaternization reaction, styrene of 214 g, butylacrylate of 72 g, and t-butylperoxy-2-ethylhexanoate (made by ARKEMA Yoshitomi, Ltd.) of 12 g as a peroxide initiator were added into the reaction container. After the temperature inside the reaction container was increased to 95° C. (polymerization temperature), the contents in the reaction container was stirred at a stirring rate of 100 rpm for 3 hours. Next, t-butylperoxyacyl-2-ethylhexanoate of 6 g was further added into the reaction container. After that, the contents in the reaction container was stirred at a stirring rate of 100 rpm for 3 hours at 95° C., and the polymerization reaction was completed so as to obtain dispersion liquid of the resin particulates. The obtained dispersion liquid of the resin particulates was freeze-dried so as to obtain powdered resin particulates A. The number average particle size of the resin particulates A was 0.10 μm, and the molecular weight was 225,000.

Note that the number average particle size of the resin particulates was measured according to the following method. First, a field emission scanning electron microscope (JSM-6700F made by JEOL Ltd.) was used so as to capture a picture of the resin particulates at a magnification of 100,000. The captured electron microscope picture was further magnified as necessary, and the number average particle size of the resin particulates was measured for 50 or more resin particulates, using a ruler, a vernier caliper, or the like.

### (Production of Resin Particulates B)

Distilled water of 450 mL and dodecylammoniumchloride of 0.52 g were put in a reaction container having a volume of 1000 mL, equipped with a stirring device, a temperature gage, a cooling pipe, and a nitrogen introduction device. The contents in the reaction container was stirred in the nitrogen atmosphere, and the temperature inside the reaction container was increased to 80° C. After the temperature increase, a water solution of potassium persulfate (polymerization initiator) of 120 g having a density of 1 mass % and ion-exchanged water of 200 g were added into the reaction container. Next, a mixture containing butyl acrylate of 15 g, methyl methacrylate of 165 g, and n-octylmercaptan (chain transfer agent) of 3.6 g was dropped into the reaction container for 1.5 hours, and then polymerization was further performed for 2 hours, so as to obtain aqueous dispersion of the resin particulates. The obtained aqueous dispersion of the resin particulates was freeze-dried, so as to obtain the resin particulates B. The number average particle size of the resin particulates B was 0.102 μm, and the mass average molecular weight was 197,000.

### (Production of Resin Particulates C)

The preparation condition of the resin particulates A described above was appropriately changed, and the resin particulates C having a different molecular weight was obtained. The mass average molecular weight of the resin particulates C was 384,000.

### Preparation of Toners of Present Disclosure 1, Comparative Example 1, Comparative Example 2, and Comparative Example 5

### (Preparation of Toner Mother Particles)

The resin particulates 10 g of the type shown in Table 1 obtained in the production example 3 were used with respect to the toner core particles of 100 g obtained in the production example 2, so as to coat the toner core particle with the resin particulates, thereby the shell layer was formed on the surface of the toner core particle. The shell forming process was performed using a powder processing device (Multipurpose Mixer MP type made by Nippon Coke & Engineering Co., Ltd.). The toner core particles and the resin particulates were put into a processing tank of the powder processing device, and were processed at the rotational frequency for the processing time shown in Table 1 so as to obtain the toner mother particles. Note that in the present disclosure 1, the temperature in the tank of the powder processing device was controlled to be in a range of 50° C. or higher and 60° C. or lower.

### (External Addition Treatment)

Titanium oxide (EC-100 made by Titan Kogyo, Ltd.) of 2.0 mass % and hydrophobic property silica (RA-200H made by Nippon Aerosil Co., LTD.) of 1.0 mass %, with respect to the mass of the toner mother particles, were added to the obtained toner mother particles, and stirred and mixed at a rotation peripheral speed of 30 m/sec for 5 minutes, using Henschel mixer (made by Mitsui Mining Co., Ltd.), so as to obtain the toner.

### Preparation of Toner of Present Disclosure 2

The resin particulates A of 10 g obtained in the production example 3 were used with respect to the toner core particles of 100 g obtained in the production example 2 by using the amorphous polyester resin b obtained in the production example 1, so as to coat the toner core particle with the resin particulates A, thereby the shell layer was formed on the surface of the toner core particle.

The shell layer was formed using a surface reformer (a particulate coating device SFP-01 type made by POWREX). The toner core particles were circulated in a fluid bed of the surface reformer at an air supply temperature of 80° C. The aqueous dispersion of 300 g containing the resin particulates A of 10 g obtained in the production example 3 was sprayed into the fluid bed of the surface reformer at a spray speed of 5 g/min for 60 minutes, so as to obtain the toner mother particles. The external addition treatment of the obtained toner mother particles was performed similarly to the present disclosure 1, so as to obtain the toner of the present disclosure 2.

### Preparation of Toner of Present Disclosure 3

The resin particulates C of 10 g obtained in the production example 3 were used with respect to the toner core particles of 100 g obtained in the production example 2 using the amorphous polyester resin a obtained in the production example 1, so as to coat the toner core particle with the resin particulates C, thereby the shell layer was formed on the surface of the toner core particle.

The shell layer was formed using the surface reformer (the particulate coating device SFP-01 type made by POWREX). The toner core particles were circulated in a fluid bed of the surface reformer at an air supply temperature of 80° C. The aqueous dispersion of 300 g containing the resin particulates C of 10 g obtained in the production example 3 was sprayed into the fluid bed of the surface reformer at a spray speed of 5 g/min for 60 minutes, so as to obtain the toner mother particles. The external addition treatment of the obtained toner mother particles was performed similarly to the present disclosure 1, so as to obtain the toner of the present disclosure 3.

### Preparation of Toner of Comparative Example 3

The resin particulates A of 10 g obtained in the production example 3 were used with respect to the toner core particles of 100 g obtained in the production example 2, so as to coat the toner core particle with the resin particulates A, thereby the shell layer was formed on the surface of the toner core particle.

The shell layer was formed using the surface reformer (the particulate coating device SFP-01 type made by POWREX). The toner core particles were circulated in a fluid bed of the surface reformer at an air supply temperature of 80° C. The aqueous dispersion of 300 g containing the resin particulates A of 10 g obtained in the production example 3 was sprayed into the fluid bed of the surface reformer at a spray speed of 5 g/min for 60 minutes, so as to obtain the toner mother particles. The external addition treatment of the obtained toner mother particles was performed similarly to the present disclosure 1, so as to obtain the toner of the comparative example 3.

### Preparation of Toner of comparative example 4

The toner core particles obtained in the production example 2 were used as the toner mother particles, and the external addition treatment was performed similarly to the present disclosure 1, so as to obtain the toner of the comparative example 4.

### Check of Structure of Shell Layer

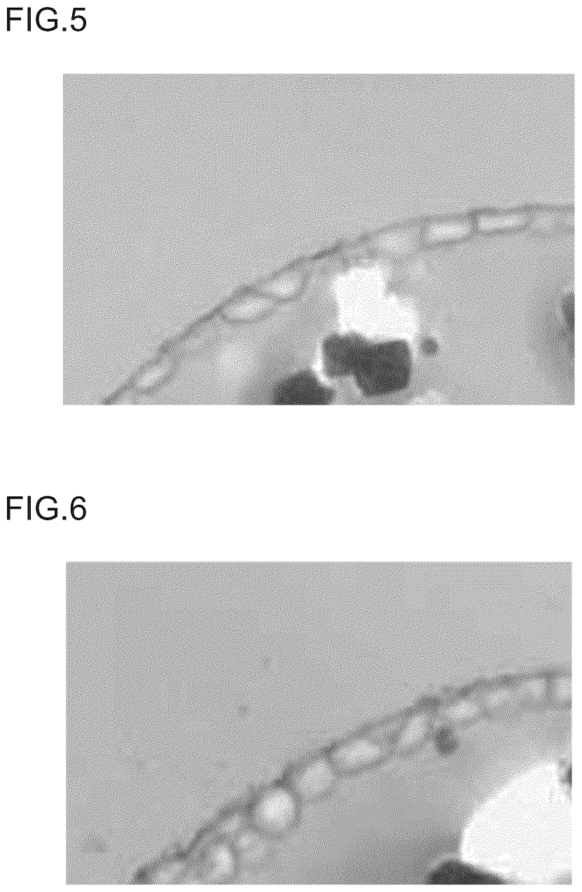

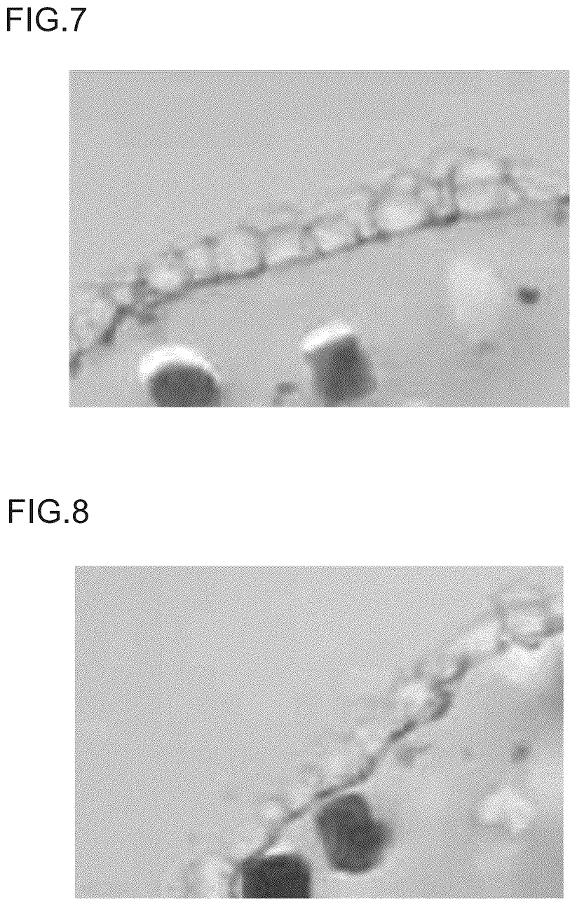

In accordance with the following method, the toner surfaces of the present disclosures 1 to 3 and the comparative examples 1 to 5 were observed using the scanning electron microscope (SEM), so as to check the coated state of the toner core particle with the shell layer, and the state of the shell layer surface. In addition, in accordance with the following method, cross section pictures of the toners of the present disclosures 1 to 3 and the comparative examples 1 to 5 were captured using the transmission electron microscope (TEM). With reference to the obtained the TEM pictures, the states of the shell layer surfaces, the states inside the shell layers, and the shapes of the inner surfaces of the shell layers were checked. FIGS. 4 to 6 respectively illustrate the TEM pictures of the toner cross sections of the present disclosures 1 to 3, and FIGS. 7 to 10 respectively illustrate the TEM pictures of the toner cross sections of the comparative examples 1 to 3, 5. Note that the toner of the comparative example 4 did not underwent the shell forming process, and hence the SEM observation of the toner surface and the TEM observation of the toner cross section were not performed for the toner of the comparative example 4.

### (Observation of Toner Surface)

Using the scanning electron microscope (JSM-6700F made by JEOL Ltd.), the toner particle surface was observed at a magnification of 10,000.

### (Method for Capturing Toner Cross Section)

A sample was made in which the toner was embedded in resin. Using a microtome (EM UC6 made by Leica), a thin sample having a thickness of 200 nm for toner cross section observation was made from the obtained sample. The obtained thin sample was observed at a magnification of 50,000 using the transmission electron microscope (JSM-6700F made by JEOL Ltd.), and an image of an arbitrary toner cross section was captured.

In the toners of the present disclosure 1 and the comparative example 5, when the observation with the scanning electron microscope (SEM) was performed on the surfaces thereof, a substantially spherical particle derived from the resin particulates used for forming the shell layer was not observed in the shell layer, for the toner particles having a particle diameter 6 μm or more and 8 μm or less. Also in the TEM pictures of the toner cross sections of the present disclosures 1 to 3 illustrated in FIGS. 4 to 6, it was confirmed that the shell layers of the toners of the present disclosures 1 to 3 did not include a substantially spherical particle on the surfaces thereof, and that the outer surfaces thereof were smooth. In the TEM pictures of the toner cross sections of the present disclosures 1 to 3, it was confirmed that there were cracks in a direction substantially perpendicular to the surface of the toner core particle inside the shell layers of the toners of the present disclosures 1 to 3. In addition, in the TEM pictures of the toner cross sections of the present disclosures 1 to 3, it was confirmed that there was a protrusion between two cracks of the shell layer on the inner surface side, in the toner of the present disclosure 1.

In addition, the toner cross section of the comparative example 5 was observed using the TEM, and in the TEM picture of the toner cross section of the comparative example 5 illustrated in FIG. 10, the shell layer structure of the toner of the comparative example 5 was the same as that of the toner of the present disclosure 1.

It was confirmed that the toners of the comparative examples 1 and 2 each have the surface of the toner core particle was coated with the resin particulates remained in the spherical particle state, when the surfaces were observed for the toner particles having a particle diameter 6 μm or more and 8 μm or less using the SEM. In addition, also in the TEM pictures of the toner cross sections of the comparative examples 1 and 2 illustrated in FIGS. 7 and 8, it was confirmed that the surface of the toner core particle was coated with the resin particulates remained in the particle state, in the toners of the comparative examples 1 and 2.

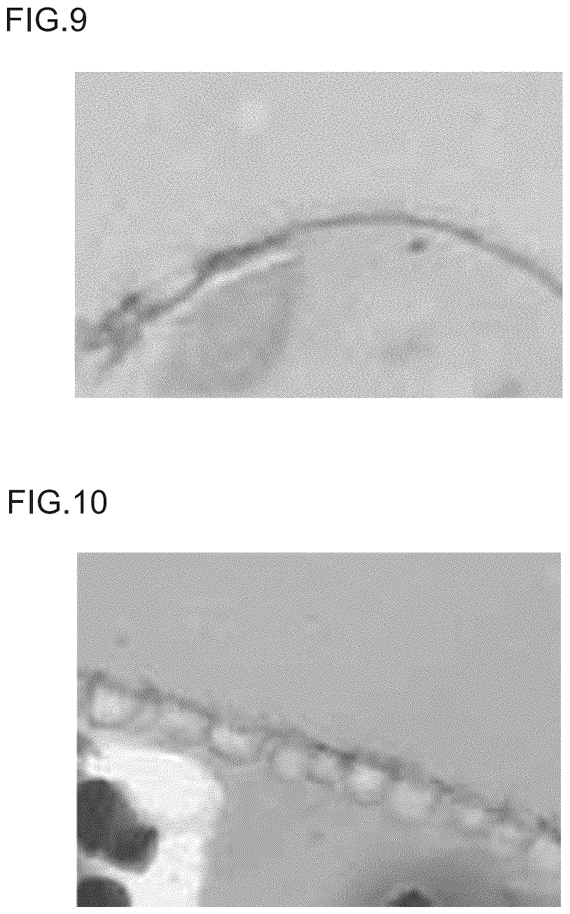

As to the toner of the comparative example 3, the surfaces of the toner particles having a diameter 6 μm or more and 8 μm or less were observed using the SEM, it was confirmed that a substantially spherical particle derived from the spherical resin particulates was not observed in the shell layer, and that the outer surface of the shell layer was smooth. In addition, also in the TEM picture of the toner cross section of the comparative example 3 illustrated in FIG. 9, it was confirmed that the outer surface of the shell layer of the toner of the comparative example 3 was smooth. However, in the TEM picture of the toner cross section of the comparative example 3, it was confirmed that there were no cracks in a direction substantially perpendicular to the surface of the toner core particle inside the shell layer of the toner of the comparative example 3. The reason of this is presumed that the shell layer was formed at a high temperature, and hence the material of the shell layer (the resin particulates A) was completely fused.

### Evaluation of Fixing Performance, Heat-Resistant Storability, Image Density, and Toner Charge Amount of Toner

In accordance with the following method, the fixing performance, the heat-resistant storability, and the image density and the toner charge amount in a predetermined environment were evaluated for the toners of the present disclosures 1 to 3 and the comparative examples 1 to 5. The evaluation result of the toners are shown in Table 1. A page printer (PA2000 made by KYOCERA Document Solutions Japan Inc.), which was remodeled so that fixing temperature can be adjusted, was used as an evaluation machine. The evaluation machine was left in a power off state for 10 minutes, and then was powered on for use.

### (Fixing Performance)

The fixing temperature was set to 180° C., and fixing was performed using a fixing heat roller having a diameter of 30 mm and a linear speed of 100 mm/sec, and an evaluation image was obtained using the evaluation machine in an environment of normal temperature and normal humidity (20° C., 65% RH). The image density of the obtained evaluation image before friction was measured using GretagMacbethSpectroEye (made by GretagMacbeth).

Next, a weight of 1 kg covered with fabric was reciprocated 10 times for friction, in such a manner that only the weight's own weight was applied on the image, and the image density after the friction was measured. A fixation ratio was calculated from the image densities before and after the friction in accordance with the following equation. The fixing performance was evaluated from the calculated fixation ratio in accordance with the following criteria. Determinations were ◯ representing acceptance, Δ, and X representing rejection.

$$fixation ratio ( \% ) = ( image density after friction ) / ( before friction image density ) \times 100$$

◯ represents a fixation ratio of 95% or more.
Δ represents a fixation ratio of 90% or more and less than 95%.
x represents a fixation ratio less than 90%.

### (Heat-Resistant Storability)

The toner was stored at 50° C. for 100 hours. Next, in accordance with the manual of the powder tester (made by Hosokawa Micron Corporation), the toner was sieved by a sieve of 140 mesh (an aperture of 105 um) under a condition of Rheostat scale 5 and 30 seconds, an agglomeration degree (%) was determined by the following agglomeration degree calculation equation, and evaluation was made in accordance with the following criteria, the evaluation being ◯ representing acceptance, Δ, and x representing rejection.

### (Agglomeration Degree Calculation Equation)

$$agglomeration degree ( \% ) = ( toner mass remaining on sieve ) / ( mass of toner before sieving ) \times 100$$

◯ represents an agglomeration degree of 20% or less.
Δ represents an agglomeration degree more than 20% and 50% or less.
x represents an agglomeration degree more than 50%.

### (Image Density and Toner Charge Amount in Predetermined Environment)

In accordance with the following method, in each of the environment of normal temperature and normal humidity (20° C., 65% RH), the environment of high temperature and high humidity (32.5° C., 80% RH), and the environment of low temperature and low humidity (10° C., 20% RH), the initial toner charge amount and image density, and the toner charge amount and image density after continuous image formation were evaluated.

### (Image Density)

Using the evaluation machine, at a fixing temperature of 180° C., an image evaluation pattern was formed on a recording medium so as to obtain an initial image. After that, continuous image formation of 2,500 sheets was performed at a print rate of 4%, and then the image evaluation pattern was formed on a recording medium so as to obtain an image after continuous image formation. Image densities of solid images in the initial image evaluation pattern and the image evaluation pattern after continuous image formation were measured with a reflection density meter (RD914 made by GretagMacbeth). The image density was evaluated in accordance with the following criteria, the evaluation being ◯ representing acceptance, Δ, and x representing rejection.
◯ represents 1.25 or more.
Δ represents less than 1.24 and 1.20 or more.
x represents less than 1.20.

### (Charge Amount)

After forming the initial image, an initial toner charge amount was measured. Next, after continuous image formation of 2,500 sheets was performed at a print rate of 4%, the toner charge amount after continuous image formation was measured. The charge amount was measured using a charge amount measurement device (Q/M Meter 210HS made by TRek). The charge amount was evaluated in accordance with the following criteria, the evaluation being ◯ representing acceptance, Δ, and x representing rejection.
◯ represents 20.0 or more and 25.0 or less.
Δ represents 19.0 or more and less than 20.0, or more than 25.0 and 26.0 or less.
1 represents less than 19.0 and more than 26.0.

### (Adhesion to Regulating Blade)

In each environment, after image formation of 2,500 sheets, adhesion to the regulating blade was visually checked. The adhesion was evaluated in accordance with the following criteria, the evaluation being ◯ representing acceptance, Δ, and x representing rejection.
◯ represents that there is no adhesion.
Δ represents that there is minor adhesion.
x represents that there is adhesion.

### (White Streak)

In each environment, after image formation of 2,500 sheets, occurrence of white streaks in the image was visually checked. The white streaks were evaluated in accordance with the following criteria, the evaluation being ◯ representing acceptance, Δ, and x representing rejection.
◯ represents that there is no occurrence.
x represents that there is occurrence.

Table 1 shows the evaluation results of the fixing performance, the heat-resistant storability, the image density, the charge amount, the adhesion to the regulating blade, and the white streaks of the toners of the present disclosures 1 to 3 and the comparative examples 1 to 5, together with production conditions of the toners.

TABLE 1

| | | Present Disclosure | | | Comparative Example | | | | |
|---|---|---|---|---|---|---|---|---|---|
| | | 1 | 2 | 3 | 1 | 2 | 3 | 4 | 5 |
| core resin | | a | b | a | a | a | a | a | a |
| core resin mo [symbol] cular weight MW | | 25000 | 40000 | 25000 | 25000 | 25000 | 25000 | 25000 | 25000 |
| resin particulate type | | A | A | C | A | A | A | — | B |
| resin particulate molecular weight MW | | 225000 | 225000 | 384000 | 225000 | 225000 | 225000 | — | 1 [symbol] 7000 |
| powder processing device conditions | | | | | | | | | |
| rotational frequency [rpm] | | [symbol] 000 | [symbol] 000 | [symbol] 000 | 4000 | 7000 | — | — | [symbol] 000 |
| processing time [min] | | 10 | 10 | 10 | 5 | 10 | — | — | 10 |
| evaluation details | | | | | | | | | |
| fixing performance | | | | | | | | | |
| fixation ratio | | [symbol] 7 | [symbol] 5 | [symbol] | [symbol] 5 | [symbol] 8 | 85 | 88 | [symbol] 5 |
| evaluation | | ∘ | ∘ | ∘ | ∘ | ∘ | x | x | ∘ |
| heat-resistant storability | | | | | | | | | |
| agglomeration degree | | [symbol] | 5 | [symbol] | 70 | 37 | 5 | 85 | 11 |
| evaluation | | ∘ | ∘ | ∘ | x | Δ | ∘ | x | ∘ |
| initial image at | image density | 1.2 [symbol] | 1.27 | 1.27 | 1.2 [symbol] | 1.27 | 1.27 | 1.1 [symbol] | 1.27 |
| normal temperature | evaluation | ∘ | ∘ | ∘ | ∘ | ∘ | ∘ | x | ∘ |
| and normal humidity | charge amount [μ [symbol] /g] | 23.1 | 22.0 | 23.2 | 21.1 | 22.4 | 24.0 | 18.8 | 22.2 |
| | evaluation | ∘ | ∘ | ∘ | ∘ | ∘ | ∘ | x | ∘ |
| after image formation | image density | 1.27 | 1.26 | 1.27 | 1.23 | 1.25 | 1.2 [symbol] | — | 1.28 |
| of 2,500 sheets at | evaluation | ∘ | ∘ | ∘ | Δ | ∘ | ∘ | — | ∘ |
| normal temperature | charge amount [μ [symbol] /g] | 22.5 | 22.5 | 23 | 1 [symbol] .8 | 22 | 23.7 | — | 22.1 |
| and normal humidity | evaluation | ∘ | ∘ | ∘ | Δ | ∘ | ∘ | — | ∘ |
| | adhesion to regulating b [symbol] | absence | absence | absence | presence | absence | absence | — | absence |
| | evaluation | ∘ | ∘ | ∘ | Δ | ∘ | ∘ | — | ∘ |
| | white streak | absence | absence | absence | presence | absence | absence | — | absence |
| | evaluation | ∘ | ∘ | ∘ | Δ | ∘ | ∘ | — | ∘ |
| initial image at high | image density | 1.26 | 1.26 | 1.27 | 1.23 | 1.25 | 1.25 | 1.15 | 1.23 |
| temperature and high | evaluation | ∘ | ∘ | ∘ | Δ | ∘ | ∘ | x | Δ |
| humidity | charge amount [μ [symbol] /g] | 21.1 | 21 | 20.8 | 20.5 | 21 | 23.3 | 18 | 1 [symbol] .5 |
| | evaluation | ∘ | ∘ | ∘ | Δ | ∘ | ∘ | x | Δ |
| after image formation | image density | 1.25 | 1.27 | 1.25 | 1.1 [symbol] | 1.2 [symbol] | 1.25 | — | 1.25 |
| of 2,500 sheets at | evaluation | ∘ | ∘ | ∘ | x | ∘ | ∘ | — | ∘ |
| high temperature and | charge amount [μ [symbol] /g] | 20. [symbol] | 20.7 | 20.4 | 18.7 | 1 [symbol] .5 | 23 | — | 20.2 |
| high humidity | evaluation | ∘ | ∘ | ∘ | x | Δ | ∘ | — | ∘ |
| | adhesion to regulating b [symbol] | absence | absence | absence | presence | absence | absence | — | absence |
| | evaluation | ∘ | ∘ | ∘ | x | ∘ | ∘ | — | ∘ |
| | white streak | absence | absence | absence | presence | absence | absence | — | absence |
| | evaluation | ∘ | ∘ | ∘ | x | ∘ | ∘ | — | ∘ |
| initial image at low | image density | 1.31 | 1.3 | 1.2 [symbol] | 1.27 | 1.27 | 1.23 | 1.24 | 1.3 |
| temperature and low | evaluation | ∘ | ∘ | ∘ | ∘ | ∘ | Δ | Δ | ∘ |
| humidity | charge amount [μ [symbol] /g] | 24.4 | 24 | 23. [symbol] | 22.2 | 23.7 | 25.5 | 1 [symbol] | 24.2 |
| | evaluation | ∘ | ∘ | ∘ | ∘ | ∘ | ∘ | Δ | ∘ |
| after image formation | image density | 1.32 | 1.32 | 1.33 | 1.25 | 1.2 [symbol] | 1.25 | — | 1.3 |
| of 2,500 sheets at | evaluation | ∘ | ∘ | ∘ | ∘ | ∘ | ∘ | — | ∘ |
| low temperature and | charge amount [μ [symbol] /g] | 24.2 | 24.5 | 24.7 | 21 | 24 | 25 | — | 24 |
| low humidity | evaluation | ∘ | ∘ | ∘ | ∘ | ∘ | ∘ | — | ∘ |
| | adhesion to regulating b [symbol] | absence | absence | absence | absence | absence | absence | — | absence |
| | evaluation | ∘ | ∘ | ∘ | ∘ | ∘ | ∘ | — | ∘ |
| | white streak | absence | absence | absence | absence | absence | absence | — | absence |
| | evaluation | ∘ | ∘ | ∘ | ∘ | ∘ | ∘ | — | ∘ |

[symbol]

indicates data missing or illegible when filed

The toner of each of the present disclosures 1 to 3 is constituted of the toner core particles each containing at least the binder resin and the shell layer having a predetermined structure that coats the entire surface of the toner core particle. The shell layer is made of resin containing the charge controlling resin, and when observing with the scanning electron microscope, a substantially spherical particle derived from the resin particulates is not viewed in the shell layers of the toner particles having a particle diameter in a specific range. In addition, when observing the cross section thereof with the transmission electron microscope, a lot of cracks are observed in a direction substantially perpendicular to the surface of the toner core particle inside the shell layer. In this way, it is understood that when images are formed for a long period of time in various environment such as high temperature and high humidity environment or low temperature and low humidity environment, the toner can be charged at a desired charge amount, and an image having a desired density can be formed regardless of the use environment.

In particular, it is understood that an image having a desired density can be formed regardless of the use environment, in non-magnetic one-component developing type developing unit 33, which includes the developing roller having the silicone rubber layer formed on the conductive base and the urethane layer formed on the top layer of the silicone rubber layer, and the regulating blade made of stainless steel that contacts the developing roller, the regulation pressure of the regulating blade being 15 to 40 N/m.

According to the toners of the comparative examples 1 and 2, if a substantially spherical particle derived from the spherical resin particulates is observed on the shell layer surface of the toner core particles, the toner having good heat-resistant storability can hardly be obtained. The reason of this is presumed that if the structure derived from the spherical resin particulates is observed in the shell layer surface, a gap is remained between the resin particulates that coat the shell layer and are deformed to some extent, and hence a component of the releasing agent or the like contained in the toner core particles easily seep to the toner surface.

In addition, it was found from the SEM observation of the toners of the present disclosures 1 to 3 and the comparative example 1, that a substantially spherical particle derived from the resin particulates is not observed on the shell layer surface, by increasing the rotational frequency of the device used for forming the shell layer. In other words, according to the present disclosures 1 to 3 and the comparative example 1, it is understood that when increasing the rotational frequency of the device used for forming the shell layer, deformation of the resin particulates proceeds, and the outer surface of the shell layer is smoothed.

According to the toner of the comparative example 1, when images are formed for a long period of time in various environment such as high temperature and high humidity environment or low temperature and low humidity environment, the toner is hardly charged at a desired charge amount, and the image having a desired density is hardly formed. The reason of this is presumed that there are the resin particulates remained in the spherical shape on the shell layer surface of the toner core particle, excessive stress is applied on the toner due to the image formation for a long period of time, the resin particulates are easily separated from the toner, and hence the separated resin particulates prevents the toner from being stably charged.

According to the toner of the comparative example 3, it is understood that if the cracks are not observed inside the shell layer in a direction substantially perpendicular to the surface of the toner core particle, it is difficult to obtain the toner having good fixing performance. The reason of this is presumed that when fixing the toner, breaking of the shell layer due to the pressure applied on the toner can hardly occur.

According to the toner of the comparative example 4, it is understood that if the toner core particle is not coated with the shell layer, it is difficult to obtain the toner having good heat-resistant storability, and it is difficult to obtain a predetermined charge amount and image density from the initial image. Note that, because of an abnormality such as toner scattering, the image formation evaluation of 2,500 sheets was not performed.

According to the comparative example 5, it is understood that, if the material of the shell layer does not contain the charge controlling resin, when an image is formed in the initial image, the toner can hardly be charged at a desired charge amount in the high temperature and high humidity environment, and an image can hardly be formed.

The present disclosure can be used for the non-magnetic one-component developing toner that is used in the electrophotographic process. Using the present disclosure, it is possible to provide the non-magnetic one-component developing toner that has good fixing performance and good heat-resistant storability, and that can be charged at a desired charge amount for a long period of time in various environments, and that can form an image having a desired density.

What is claimed is:

1. Non-magnetic one-component developing toner comprising toner particles each including a toner core particle containing at least binder resin and a shell layer coating the toner core particle, the toner particle containing no magnetic powder, wherein
the shell layer is formed using spherical resin particulates containing charge controlling resin,
when a surface of the toner particle is observed using a scanning electron microscope, a structure derived from the spherical resin particulates is not observed in the shell layer, and an outer surface of the shell layer is smoothed, of the toner particles having an average particle size of 6 μm or more and 8 μm or less, and
when a cross section of the toner particle is observed using a transmission electron microscope, a crack derived from an interface between the resin particulates is observed inside the shell layer, in a direction substantially perpendicular to a surface of the toner core particle.

2. The non-magnetic one-component developing toner according to claim 1, wherein mass average molecular weight of the resin particulates is 200,000 or more and 400,000 or less.

3. The non-magnetic one-component developing toner according to claim 1, wherein thickness of the shell layer is 0.05 μm or more and 0.3 μm or less.

4. The non-magnetic one-component developing toner according to claim 1, wherein when a cross section of the electrostatic latent image developing toner is observed using a transmission electron microscope, protrusions of the shell layer are observed at an interface between the toner core particle and the shell layer, each protrusion being between two cracks.

5. A method for producing the non-magnetic one-component developing toner according to claim 1, the method comprising the steps (I) and (II) for forming the shell layer:
(I) allowing the spherical resin particulates to adhere to the surface of the toner core particle, so as to form a resin particulate layer coating at least a part of the surface of the toner core particle; and
(II) applying an external force on the outer surface of the resin particulate layer, so as to deform te resin particulates in the resin particulate layer, thereby smoothing the outer surface of the resin particulate layer to form the shell layer.

6. A developing device using the non-magnetic one-component developing toner according to claim 1, wherein
the developing device includes a developing roller having an outer periphery carrying the toner so as to form a toner layer, and a regulating blade contacting the outer periphery of the developing roller so as to regulate thickness of the toner layer,
the developing roller has a silicone rubber layer formed on a conductive base, and a urethane layer formed on a top layer of the silicone rubber layer, and
the regulating blade is made of stainless steel, and a regulation pressure by the regulating blade is 15 to 40 N/m.

7. An image forming apparatus comprising the developing device according to claim 6.
